(19) United States
(12) Patent Application Publication
(10) Pub. No.: US 2022/0114968 A1
(43) Pub. Date: Apr. 14, 2022

(54) GOA CIRCUIT, PIXEL CIRCUIT, DISPLAY DEVICE AND METHOD FOR DRIVING DISPLAY

(71) Applicant: Shenzhen Royole Technologies Co., Ltd., Shenzhen (CN)

(72) Inventor: Ximeng Guan, Shenzhen (CN)

(21) Appl. No.: 17/226,846

(22) Filed: Apr. 9, 2021

Related U.S. Application Data
(63) Continuation of application No. PCT/CN2018/120050, filed on Dec. 10, 2018.

(30) Foreign Application Priority Data
Oct. 10, 2018 (CN) PCT/CN2018/109648

(51) Int. Cl. G09G 3/3266

(52) U.S. Cl. CPC G09G 3/3266; G09G 2300/0408; G09G 2300/0814; G09G 2310/08; G09G 2310/0291; G09G 2300/0857

(57) ABSTRACT

A GOA circuit includes a plurality of GOA units independent of each other, wherein each of the plurality of GOA units includes an enable module and a drive module; wherein the enable module includes an address input terminal, and an enable signal output terminal; and the drive module includes an enable signal input terminal configured to receive the enable signal output by the enable signal output terminal, and a drive signal output terminal configured to output drive signals having different pulse widths based on the enable signal, wherein the drive signal output terminal is connected to a gate line of a row disposed corresponding to the drive module to transmit the drive signal to the gate line of the row and gate the row.

### TECHNICAL FIELD

The present disclosure relates to the technical field of display panels, and in particular, relates to a GOA circuit, a pixel circuit, a display device, and a method for driving a display.

### BACKGROUND

Displays based on an organic light-emitting diode (OLED), a micro LED, and a quantum dot LED all need to be driven by a backplane display circuit having a current output capability. A traditional backplane display circuit is generally formed by single-polarity transistors (or N-type transistors or P-type transistors). The core elements include a pixel array and a gate driver on array (GOA) circuit configured to drive the pixel array. The traditional backplane display circuit is restricted by the single-polarity of the transistors, and encounters some challenges in both the pixel circuit and the GOA circuit.

GOA circuits are widely applied in LCDs, AMOLEDs, and the like electronic display devices. The GOA circuit is a key part of a display panel, and is configured to supply a scanning pulse signal to a pixel array.

A traditional GOA circuit is only capable of supplying scanning pulses having a specific width, and thus fails to accommodate requirement that a pixel circuit having an internal compensation function simultaneously needs scanning pulses having two widths.

The traditional GOA circuit is based on the basic design that a previous stage triggers a following stage, and is generally constituted by a bootstrap capacitor and a single-polarity transistor. Based on this design, the pixel array may only be orderly scanned, but may not be randomly scanned.

When the screen includes n rows of pixels, these pixels are scanned row by row with a refresh frequency of 60 Hz, and a time of 1/60/N is assigned to each row. A capacitive load of a clock line for driving the GOA is proportional to C_{gon}+Cₒᵥ*(N−1)+Cₚᵢₓₑₗ. C_{gon} represents a load contribution of an activated GOA to the clock line, Cₒᵥ represents a load contribution of the remaining N−1 stages of GOAs to the clock line, and Cₚᵢₓₑₗ represents a load contribution of all the pixels in a row being scanned. When the size of an output transistor of the GOA increases, C_{gon} and Cₒᵥ may both increase proportionally.

When the size of the screen constantly increases, the resolution constantly increases, and the pixel density constantly increases, more and more challenges are caused to the GOA circuit as follows:

The number of pixels in each row increases, and the load (Cₚᵢₓₑₗ) of the GOA circuit increases.

The size of the pixels in each row decreases, the available area for the GOA circuit cooperated with the pixels constantly decreases, the size of the transistors for fabricating the GOA circuit is further restricted, and thus the drive capability is degraded.

The increase of the absolute number of rows causes the scanning time for each row to constantly decrease ( 1/60/N). To accommodate more stricter timing requirements, the size of the output transistors of the GOA circuit needs to be increased. This requirement is not only in contradiction with the decrease of the area, but also causes C_{gon} and Cₒᵥ to constantly increase.

The increase of the absolute number of rows causes the number of stages (N−1) of the GOA units in a turn-off state to constantly increase, causes the load of the clock lines to correspondingly increase, and cause useless power to increase.

The increase of the absolute number of rows increases the probability that the GOA circuit becomes defective. Once a stage of GOA unit fails, the following stages of GOA units may fail, and consequently, the screen may be damaged.

Due to the above factors, when the traditional GOA circuit structure is applied to screens with constantly increasing size, resolution and pixel density, more and more severe challenges occur, the timing fails to be accommodated, the power consumption constantly increases, and the yield constantly decreases.

### SUMMARY

In view of the above technical effects, the present disclosure provides a gate driver on array (GOA) circuit, a pixel circuit in cooperation with the GOA circuit, and a display device including the GOA circuit and the pixel circuit.

The present disclosure provides a gate driver on array (GOA) circuit. The GOA circuit includes a plurality of GOA units independent of each other, wherein each of the plurality of GOA units includes an enable module and a drive module disposed corresponding to the enable module; wherein

the enable module includes an address input terminal configured to receive a row address signal, and an enable signal output terminal configured to output an enable signal based on the row address signal; and

the drive module comprises an enable signal input terminal configured to receive the enable signal output by the enable signal output terminal, and a drive signal output terminal configured to output drive signals having different pulse widths based on the enable signal, wherein the drive signal output terminal is connected to a gate line of a row disposed corresponding to the drive module to transmit the drive signal to the gate line of the row and gate the row.

The present disclosure further provides a pixel circuit having an internal compensation effect. The pixel circuit is in cooperation with the GOA circuit as described above. The pixel circuit includes a first transistor T1, a second transistor T2, a third transistor T3, a fourth transistor T4, a fifth transistor T5, a capacitor Cₛ, a node, and a light-emitting unit; wherein

a second electrode of the first transistor T1 is connected to a data signal, a first electrode of the first transistor T1 is connected to a second electrode of the fourth transistor T4 and a first electrode of the second transistor T2, and a third electrode of the first transistor T1 and a third electrode of the fifth transistor T5 are connected to a second output terminal of a drive module in the GOA circuit; and

a first electrode of the fourth transistor T4 is connected to a high level, a third electrode of the fourth transistor T4 and a third electrode of the third transistor T3 are connected to a first output terminal of the drive module in the GOA circuit, a second electrode of the second transistor T2 and a second electrode of the third transistor T3 are collectively connected to a first electrode of the fifth transistor T5, a second electrode of the fifth transistor T5 is connected to a positive electrode of the light-emitting unit, a negative electrode of the light-emitting unit is connected to a low level, a first electrode of the third transistor T3 is connected to the node and the capacitor Cₛ in sequence and then connected to a high level, and the node is further connected to a third electrode of the second transistor T2.

The present disclosure further provides a pixel circuit having an internal compensation effect. The pixel circuit is in cooperation with the GOA circuit as described above. The pixel circuit includes a first transistor T1, a second transistor T2, a third transistor T3, a fourth transistor T4, a capacitor Cₛ, a node, and a light-emitting unit; wherein

a second electrode of the first transistor T1 is connected to a data signal, a first electrode of the first transistor T1 is connected to a second electrode of the fourth transistor T4 and a first electrode of the second transistor T2, and a third electrode of the first transistor T1 is connected to a second output terminal of a drive module in the GOA circuit; and

a first electrode of the fourth transistor T4 is connected to a high level, a third electrode of the fourth transistor T4 and a third electrode of the third transistor T3 are connected to a first output terminal of the drive module in the GOA circuit, a second electrode of the second transistor T2 and a second electrode of the third transistor T3 are collectively connected to a positive electrode of the light-emitting unit, a negative electrode of the light-emitting unit is connected to a low level, a first electrode of the third transistor T3 is connected to the node and the capacitor Cₛ in sequence and then connected to a high level, and the node is further connected to a third electrode of the second transistor T2.

The present disclosure further provides a display device. The display device includes the GOA circuit as described above and the pixel circuit having the internal compensation effect as described above.

The present disclosure further provides a method for driving a display. The method includes:

inputting an address signal to a row decoder in a gate driver on array (GOA) circuit of a display;

enabling the row decoder corresponding to the address signal;

outputting an enable signal to a pulse generator in the GOA circuit by the enabled row decoder; and

generating a pulse signal by the pulse generator to drive pixels in a corresponding row to operate.

The GOA circuit according to the embodiments of the present disclosure is capable of generating long and short pulse signals configured to drive pixels in various rows, and may be directly cooperated with the pixel circuit. As compared with the conventional GOA circuit only capable of supplying scanning pulses having a single width, the GOA circuit according to the embodiments of the present disclosure is capable of supplying scanning pulses having two different widths that are desired by the pixel circuit having the internal compensation function. That is, the GOA circuit according to the present disclosure is capable of simultaneously generating pulse signals having two different widths, without the need of a doubled circuit area and without increasing a bezel area and power consumption.

The present disclosure provides a GOA circuit supporting random addressing. The GOA circuit allows data to be written into the screen not in accordance with rows. A majority region of the screen displays static images and only a small portion of the screen is constantly varying, and only this portion needs to be programmed. In addition, since the rows with static images are not gated, and thus dynamic power consumption is effectively reduced and meanwhile the time left for each row with varying images, such that real-time and dynamic adjustment may be achieved between display size, display power and display refresh rate.

Further, in the GOA circuit according to the present disclosure, trigger of a later stage does not rely on trigger of a previous stage. Therefore, when a separated-stage GOA unit fails, functions of the remaining GOA units are not affected, such that rating of the screen are improved, thereby providing possibilities of dynamic repair of the screen. In addition, the GOA circuit according to the present disclosure does not employ a traditional bootstrap structure. In some embodiments, a clock line does not need to directly drive an output transistor in the GOA unit. Therefore, impacts caused by (N−1) stages of inactive GOA units to the dynamic power consumption and delay may be greatly mitigated. Therefore, the GOA circuit according to the present disclosure is applicable to high-resolution and large-size screens. Further, the pixel circuit in the display device according to the present disclosure achieves the following merits: The high-drive P-type transistor provides a sufficient light-emitting current and saves the pixel area; the low-drain current N-type transistor maintains voltage data complete, and allows a variable fresh rate; the input drive waveform is simple, and the requirement on the storage capacitor is not high; the light-emitting current is substantially determined by the drive transistor, and is insensitive to OLED aging; the pixel circuit has the internal compensation function, and is capable of compensating for the temporary or permanent fluctuations of the threshold voltage of the high-drive P-type transistor caused by process fluctuations, electrical pressure, material aging, or mechanical stress, such that the life time of the screen is prolonged and the uniformity of the screen is improved.

### BRIEF DESCRIPTION OF THE DRAWINGS

The present disclosure is further described with reference to the accompanying drawings and exemplary embodiments. Among the drawings:

FIG. 1 is a schematic structural diagram of a single GOA unit in a GOA circuit according to an embodiment of the present disclosure;

FIG. 2 is a circuit diagram of a decoder based on sequential coding;

FIG. 3 is a circuit principle diagram of a row decoder practiced by an N-type transistor according to the present disclosure;

FIG. 4 is a circuit principle diagram of a row decoder practiced by a P-type transistor according to the present disclosure;

FIG. 5a schematically illustrates a layout design diagram of a row decoder practiced by N-type transistors (transistors are not combined), FIG. 5b schematically illustrates a layout design diagram of a row decoder with transistors combined based on a preset condition according to the present disclosure, and FIG. 5c is a circuit principle diagram of FIG. 5b;

FIG. 6a schematically illustrates a current flow of a row decoder practiced by N-type transistors (transistors are not combined), and FIG. 6b schematically illustrates a current flow of a row decoder with transistors combined based on a preset condition according to the present disclosure;

FIG. 7 is a circuit principle diagram of a first embodiment illustrating a reset module according to the present disclosure;

FIG. 8 is a circuit principle diagram of a second embodiment illustrating the reset module according to the present disclosure;

FIG. 9 is a schematic structural diagram of a positive edge flip-flop illustrated in FIG. 8;

FIG. 10 is a circuit principle diagram of a first embodiment of a pulse generator employed by the GOA circuit according to the present disclosure.

FIG. 11 is a circuit principle diagram of a first embodiment illustrating a latch in FIG. 10 according to the present disclosure;

FIG. 12 is a circuit principle diagram of a second embodiment illustrating the latch in FIG. 10 according to the present disclosure;

FIG. 13 is a circuit principle diagram of a buffer amplifier according to an embodiment of the present disclosure;

FIG. 14 is an operating timing of a GOA circuit employing the pulse generator in FIG. 10;

FIG. 15 is a circuit principle diagram of a second embodiment illustrating the pulse generator employed by the GOA circuit according to the present disclosure.

FIG. 16 is an operating timing of a GOA circuit employing the pulse generator in FIG. 15;

FIG. 17 is a circuit principle diagram of a complete embodiment illustrating a first GOA circuit according to the present disclosure;

FIG. 18 is a single-stage operating timing and a simulation timing of the first GOA circuit in FIG. 17;

FIG. 19 is a circuit principle diagram of a complete embodiment illustrating a second GOA circuit according to the present disclosure;

FIG. 20 is a single-stage operating timing and a simulation timing of the first GOA circuit in FIG. 19;

FIG. 21 is a schematic diagram of cascading of a first GOA circuit and a second GOA circuit according to the present disclosure;

FIG. 22 is a global timing of the cascading of the first GOA circuit according to the present disclosure;

FIG. 23 is a global simulation timing of the cascading of the first GOA circuit according to the present disclosure;

FIG. 24 is a global timing of the cascading of the second GOA circuit according to the present disclosure;

FIG. 25 is a global simulation timing of the cascading of the second GOA circuit according to the present disclosure;

FIG. 26 is a circuit principle diagram of a complete embodiment illustrating a third GOA circuit according to the present disclosure;

FIG. 27 is a single-stage timing of the GOA circuit in FIG. 26;

FIG. 28 is a single-stage simulation timing of the GOA circuit in FIG. 26;

FIG. 29 is a schematic diagram of cascading of the third GOA circuit according to the present disclosure.

FIG. 30 is a global timing of the GOA circuit in FIG. 29;

FIG. 31 is a global simulation timing of the GOA circuit in FIG. 29;

FIG. 32 is a circuit principle diagram of a first embodiment illustrating a pixel circuit in cooperation with the GOA circuit according to the embodiments of the present disclosure;

FIG. 33 is a timing of the circuit in FIG. 12;

FIG. 34 is a circuit principle diagram of a second embodiment illustrating the pixel circuit in cooperation with the GOA circuit according to the embodiments of the present disclosure; and

FIG. 35 is a schematic flowchart of a method for driving a display according to an embodiment of the present disclosure.

### DETAILED DESCRIPTION

For clearer descriptions of the technical features, objectives, and the technical effects of the present disclosure, the specific embodiments of the present disclosure are hereinafter described with reference to the accompanying drawings.

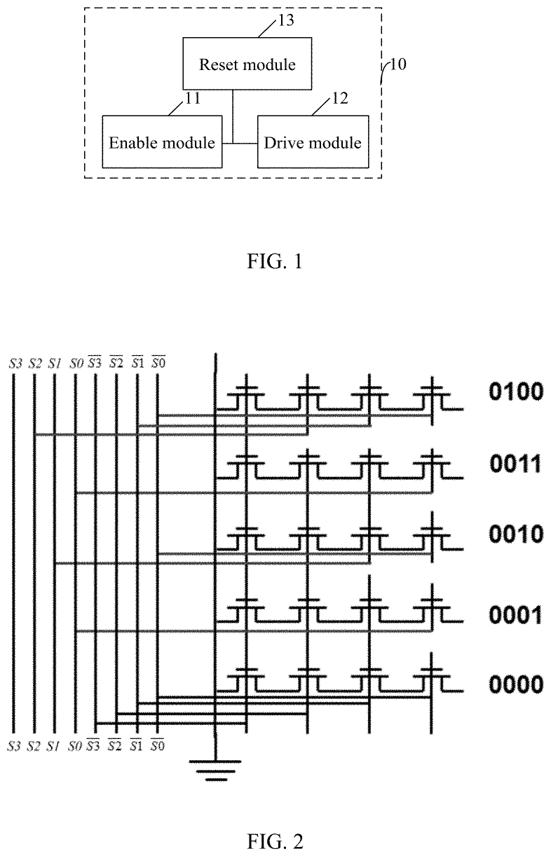

FIG. 1 is a schematic structural diagram of a first embodiment illustrating a GOA circuit according to the present disclosure.

As illustrated in FIG. 1, the GOA circuit according to this embodiment includes a plurality of GOA units 10 independent of each other, wherein each of the plurality of GOA units includes an enable module 11 and a drive module 12 disposed corresponding to the enable module 11. The GOA circuit according to the present disclosure is based on polarity complementary transistors. That is, an N-type transistor and a P-type transistor are simultaneously disposed on a panel.

Further, each of the plurality of GOA units 10 further includes a reset module 13 connected to the enable signal output terminal of the enable module 11 and configured to reset the enable module 11 in response to the drive module 12 outputting the drive signal and gating the corresponding row. Each of the plurality of reset modules 13 is disposed corresponding to each row decoder.

After any row decoder of the row decoders outputs an enable signal, and causes the drive module 12 to output a drive signal, the reset modules 13 in this row are all reset, such that a row to which the drive signal is output is reselected when a next row address signal comes in. Specifically, if the enable signal output by the enable module 11 is a high level (1), the reset module 13 may reset the enable signal to a low level (0); and if the enable signal output by the enable module 11 is the low level (0), the reset module 13 resets the enable signal to the high level (1).

The enable module 11 includes a row address signal input terminal configured to receive a row address signal, and an enable signal output terminal configured to output an enable signal based on the row address signal.

Herein, it should be noted that the present disclosure does not limit the source of the address signal. In some embodiments, the row address signal may be generated by an external drive IC. However, in some other embodiments, the row address signal may also be generated by a display screen. For example, when the display screen is capable of providing two types of polarity complementary transistors, a dedicated circuit is designed on the display screen. The dedicated circuit is capable of directly generating the row address signal, and thus the row address signal does not need to be supplied by the external drive IC.

Optionally, the enable module 11 according to the embodiment of the present disclosure is a row decoder based on binary coding, or a row decoder based on Gray coding. Each row decoder includes a plurality of transistors connected in series, wherein two transistors in adjacent rows and in a same column may be combined to a transistor when satisfying a preset condition.

By using the row decoder according to the embodiment of the present disclosure, random addressing may be implemented, data is allowed to be written into the screen not in a row order, and later-stage trigger is not dependent on previous-stage trigger, which effectively improves yield and grade of the screen, and provides possibilities to dynamically repair the screen. In addition, by using the row decoder based on Gray coding, transverse cross lines in the layout may be reduced, more transistors are allowed to be combined, and thus dynamic power consumption is reduced in the mostly commonly used sequential scanning.

Hereinafter, a comparison is made between the row decoder based on sequential coding and the row decoder according to the present disclosure in terms of design.

As illustrated in FIG. 2, a circuit principle diagram of a row decoder based on sequential coding is illustrated. The row decoder takes a 4-bit 16-stage GOA as an example. If the row decoder is designed based on sequential coding, then a 0^{th}-stage code is 0000, a first-stage code is 0001, . . . , a fifteenth-stage code is 1111, which are listed in Table 1.

TABLE 1

| Stage | Code | Row address signal |
|---|---|---|
| 0 | 0000 | S̅3̅S̅2̅S̅1̅S̅0̅ |
| 1 | 0001 | S̅3̅S̅2̅S̅1̅S0 |
| 2 | 0010 | S̅3̅S̅2̅S1S̅0̅ |
| 3 | 0011 | S̅3̅S̅2̅S1S0 |
| 4 | 0100 | S̅3̅S2S̅1̅S̅0̅ |
| 5 | 0101 | S̅3̅S2S̅1̅S0 |
| 6 | 0110 | S̅3̅S2S1S̅0̅ |
| 7 | 0111 | S̅3̅S2S1S0 |

As seen from FIG. 2, a plurality of transverse cross lines are present in a decoder based on sequential coding, and each row requires a different number of transverse cross lines. With respect to a 2N-stage decoder, in a worst condition, between a 2^{N-1}-1 stage and a 2^{N-1} stage, the number of required transverse cross lines reaches (N−1). Due to a large number of transverse cross lines, some impacts are inevitably caused to the screen. For example, the row height is occupied, and the increase of the pixels per inch (PPI) is restricted; the mutual inductance between connecting lines is increased, signal crosstalk is caused and the load of the connecting lines is increased, and the dynamic power consumption and the delay are increased; and repair is inconvenient and it is difficult to improve the yield.

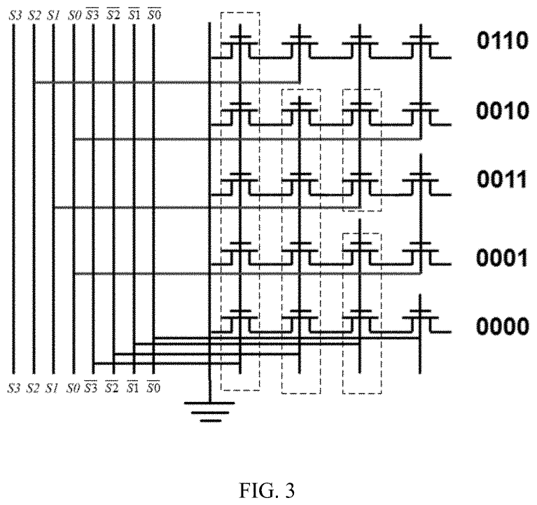

With respect to the row decoder based on Gray coding according to the present disclosure, as known from the characteristic of Gray coding, two adjacent codes have only one different bit. Therefore, each row decoder according to the present disclosure only needs one transverse cross line. This characteristic is irrelevant to the resolution of the screen. That is, regardless of whether FHD or 4K UHD, when the GOA row decoder according to the present disclosure is employed, only one transverse cross line is needed in each row. A circuit principle diagram of the row decoder based on Gray coding according to a specific embodiment of the present disclosure is as illustrated in FIG. 3. The row decoder according to this embodiment takes a 4-bit 16-stage GOA as an example, and in this example, a first-stage code is 0010, a second-stage code is 0011, a third-stage code is 0100, . . . , a fifteenth-stage code is 1000, which are listed in Table 2.

TABLE 2

| Stage | Code | Row address signal |
|---|---|---|
| 0 | 0000 | S̅3̅S̅2̅S̅1̅S̅0̅ |
| 1 | 0001 | S̅3̅S̅2̅S̅1̅S0 |
| 2 | 0010 | S̅3̅S̅2̅S1S0 |
| 3 | 0011 | S̅3̅S̅2̅S1S̅0̅ |
| 4 | 0100 | S̅3̅S2S1S̅0̅ |
| 5 | 0101 | S̅3̅S2S1S0 |
| 6 | 0110 | S̅3̅S2S̅1̅S0 |
| 7 | 0111 | S̅3̅S2S̅1̅S̅0̅ |

It is herein to be noted that in the principle diagrams in FIG. 2 and FIG. 3, the transistor is an N-type transistor and has only 16 stages and 4 address bits. However, the application scope of the present disclosure shall include cases of N-type and P-type transistors and any number of stages. In addition, in FIG. 2 and FIG. 3, the symbol of the transistor only indicates that a transistor is needed there, instead of indicating the number of transistors there. Particularly, in the principle diagram in FIG. 3, if two transistors in the adjacent rows and in the same column satisfy the preset conditions, the two transistors may be combined into one transistor. That is, two transistors in the adjacent rows and in the same column may be combined to a transistor having a larger size and a powerful drive capability if satisfying the preset condition.

The fact that two transistors in the adjacent rows and in the same column satisfy the preset condition includes: the gates of the two transistors being shorted together, and each of the two transistors being an uppermost transistor in the row decoder; or gates of the two transistors being shorted together, and upper transistors adjacent to the two transistors having been combined.

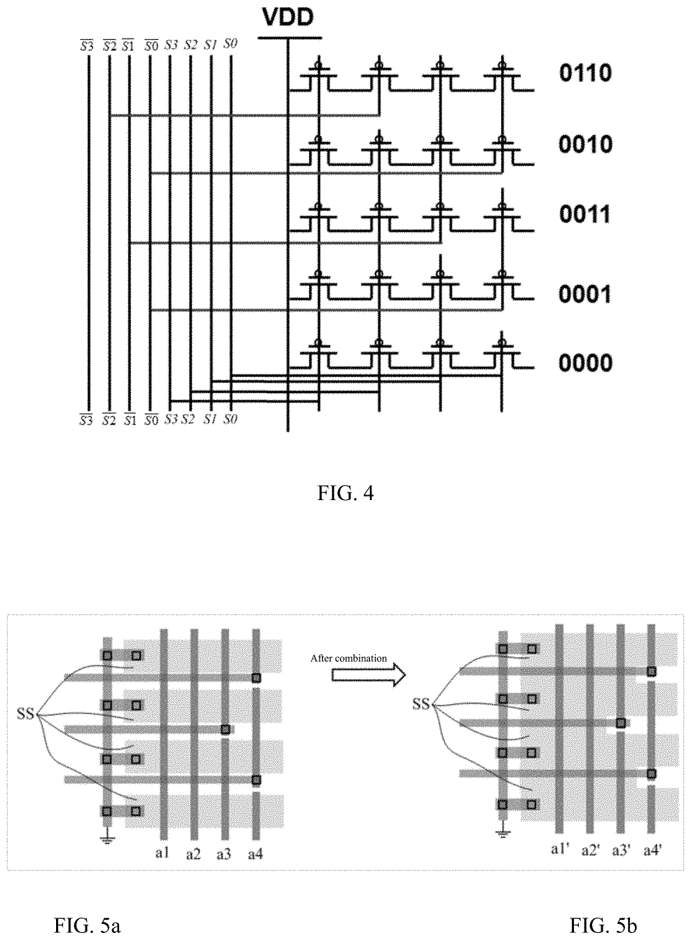

Nevertheless, the row decoder according to the present disclosure may also be practiced by a P-type transistor, wherein the practice of the P-type transistor is similar to that of the N-type transistor, and the difference lies in that code 0 corresponds to a positive signal, and code 1 corresponds to a negative signal, and a voltage polarity of the P-type transistor is symmetric to that of the N-type transistor. Specifically, the circuit principle diagram of the row decoder practiced by the P-type transistor is as illustrated in FIG. 4, and the specific code is as listed in Table 3.

TABLE 3

| Stage | Code | Row address signal |
|---|---|---|
| 0 | 0000 | S3S2S1S0 |
| 1 | 0001 | S3S2 S1S̅0̅ |
| 2 | 0010 | S3S2S̅1̅S̅0̅ |
| 3 | 0011 | S3S2S̅1̅S0 |
| 4 | 0100 | S3S̅2̅S̅1̅S0 |
| 5 | 0101 | S3S̅2̅S̅1̅S̅0̅ |
| 6 | 0110 | S3S̅2̅S1S̅0̅ |
| 7 | 0111 | S3S2S̅1̅S0 |

Likewise, the condition of combination of the transistors in the row decoder practiced by the P-type transistor is the same as that in the row decoder practiced by the N-type transistor, which is not described herein any further.

Further, as illustrated in FIG. 5b, a layout design of the row decoder practiced by the N-type transistor according to the present disclosure is illustrated. According to the present disclosure, the row decoder is practiced by connecting in series of the transistors as described above, such that the layout of the row decoder is very compact, thereby saving the area and shortening the delay.

Specifically, as illustrated in FIG. 5b, the transistors in the same row are connected in series, and thus sources and drains of the adjacent transistors in the same row may be shared, with no need of connection via metals and contact holes. This design scheme not only saves the transverse area, but also effectively prevents the impacts caused by contact resistance and load capacitance caused by metal connecting lines.

FIG. 5a schematically illustrates the layout of the transistors that are not combined, and FIG. 5b schematically illustrates the layout of the transistors that are combined.

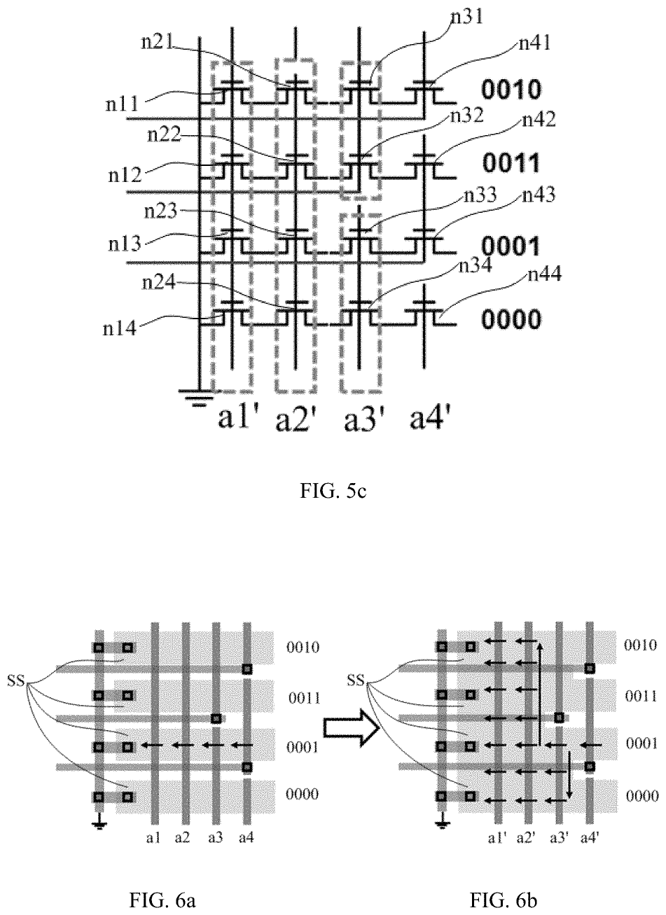

As illustrated in FIG. 5a, with respect to transistors (n11 to n14) in a leftmost first column (a1), according to the preset condition, since gates of these transistors are shorted together, and each of these transistors is an uppermost transistor in the corresponding row, the transistors (n11 to n14) in the leftmost first column (a1) may be combined, and the layout after the combination of these transistors is as illustrated in a leftmost first column (a1′) in FIG. 5b. Then, with respect to transistors in a second column (a2) from the left in FIG. 6a, since gates of these transistors are shorted together, and upper adjacent transistors of these transistors, that is, the transistors (n11 to n14) in the leftmost first column (a1), have been combined. Therefore, according to the preset condition, transistors (n21 to n24) in the second column (a2) from the left may also be combined, and the layout after the combination of these transistors is as illustrated in a second column (a2′) from the left in FIG. 5b. Afterwards, with respect to transistors in a third column (a3) from the left in FIG. 5a, since gates of these transistors are not all shorted together (as illustrated in FIG. 6c, the gate of a transistor n31 is shorted to the gate of a transistor n32, the gate of a transistor n33 is shorted to the gate of a transistor n34, but the gate of the transistor n32 is not shorted to the gate of the transistor n33), four transistors (n31 to n34) in this column may not totally combined. However, the gates of two upper transistors (the transistor n31 and the transistor n32) are respectively shorted to the gates of two lower transistors (the transistor n33 and the transistor n34), and upper transistors, that is, the transistors (n21 to n24) in the second column (a2) from the left, of these transistors have been combined. Therefore, according to the preset condition, the two upper adjacent transistors (the transistor n31 and the transistor n32) may be respectively combined with the two lower transistors (the transistor n33 and the transistor n34), and the layout after the combination of these transistors is as illustrated in a third column (a3′) from the left in FIG. 5b. Finally, with respect to a lowest column (a4), among four transistors (n41 to n44), gates of only two middle transistors (a transistor n42 and a transistor n43) may be shorted together. However, upper adjacent transistors (the transistor n32 and the transistor n33) of these two middle transistors (the transistor n42 and the transistor n43) have not combined. Therefore, these four transistors (n41 to n44) do not satisfy the preset condition and thus may not be combined. Accordingly, among the four transistors (n41 to n44) in the lowest column (a4), no two transistors may be combined, and thus the layout after the combination of the row decoder is as illustrated in FIG. 5b. The circuit principle diagram of FIG. 5b is as illustrated in FIG. 5c. In FIG. 5c, the transistors in the dotted-line block are combined.

It should be noted herein that the combination may be interpreted as that active regions of the transistors originally pertaining to different rows may be fused in the layout (as illustrated in a gray region (SS) in FIG. 5a). Through the fusion, a width of the active regions may be increased, that is, the width of the transistors is increased, and thus a higher drive current (or equivalently, an even lower turn-on resistance) may be acquired. In addition, edges of mutually separated active regions need to satisfy a design rule of a minimum process spacing, and this rule does not need to be considered upon the fusion. In this way, requirements on mask fabrication and photolithography are both lowered, and yield of the process is greatly improved.

Further description is given hereinafter to advantages of the combined row decoder with reference to FIG. 6a and FIG. 6b.

As illustrated in FIG. 6a, the case where row 0001 is selected is considered. Where no combination is made, the current may only flow through four TFTs connected in series in this row. When a combination is made, the current, when flowing towards the upper transistors, may be quickly dispersed into a wider path (as illustrated in FIG. 6b). Since the resistance is in negative proportion to the width of the current path, and the upper the transistors the current flows to, the smaller the resistance, a total resistance discharging the enable terminal is smaller than that in the case of no combination, that is, the decoding speed is higher.

Assuming that an effective resistance after a single transistor is turned on is R in the case of no combination, then an affective resistance after two transistors are combined is lowered to R/2. Therefore, in the case of no combination, a total discharging resistance of each row is 4*R; and in the case of a combination, the total discharging resistance is R*(1+½+¼+⅛)<2*R (geometrical series). In consideration of a screen having 4096 rows, a 14-bit address is desired, and 14 transistors need to be connected in series. In the case of no combination, a total resistance is 14*R; and in the case of a combination, the total resistance is R*(1+½+¼+⅛+ . . . + 1/4096)<2*R. according to the characteristics of the geometrical series, the total discharging resistance upon the combination may not proportionally increase with increase of the number of resolution rows, but an upper limit is defined. Therefore, discharging time, that is, decoding time, is not affected by the increase of the resolution upon the combination. Therefore, with the combination, the row decoder is capable of supporting a high-resolution screen, such that the decoding speed is substantially irrelevant to the increased address line.

The drive module 12 includes an enable signal input terminal connected to the enable signal output terminal of the enable module 11 and configured to receive the enable signal output by the enable signal output terminal, and a drive signal output terminal configured to output a drive signal based on the enable signal, wherein the drive signal output terminal is connected to a gate line of a row disposed corresponding to the drive module 12 to transmit the drive signal to the gate line of the row and gate the row.

Optionally, the drive signal output by the drive module 12 is a pulse signal. The drive module 12 may be a pulse generator.

As a solution, the present disclosure provides a GOA circuit supporting random addressing. The GOA circuit allows data to be written into the screen not in accordance with rows. A majority region of the screen displays static images and only a small portion of the screen is constantly varying, and only this portion needs to be programmed. In addition, since the rows with static images are not gated, and thus dynamic power consumption is effectively reduced and meanwhile the time left for each row with varying images, such that real-time and dynamic adjustment may be achieved between display size, display power and display refresh rate.

Further, in the GOA circuit according to the present disclosure, trigger of a later stage does not rely on trigger of a previous stage. Therefore, when a separated-stage GOA unit 10 fails, functions of the remaining GOA units 10 are not affected, such that yield and rating of the screen are improved, thereby providing possibilities of dynamic repair of the screen. In addition, the GOA circuit according to the present disclosure does not employ a traditional bootstrap structure. A clock line does not need to directly drive an output transistor in the GOA unit. Therefore, impacts caused by (N−1) stages of inactive GOA units to the dynamic power consumption may be greatly mitigated.

Therefore, the GOA circuit according to the present disclosure is applicable to high-resolution and large-size screens.

Two embodiments illustrating the reset module 13 according to the present disclosure are described hereinafter.

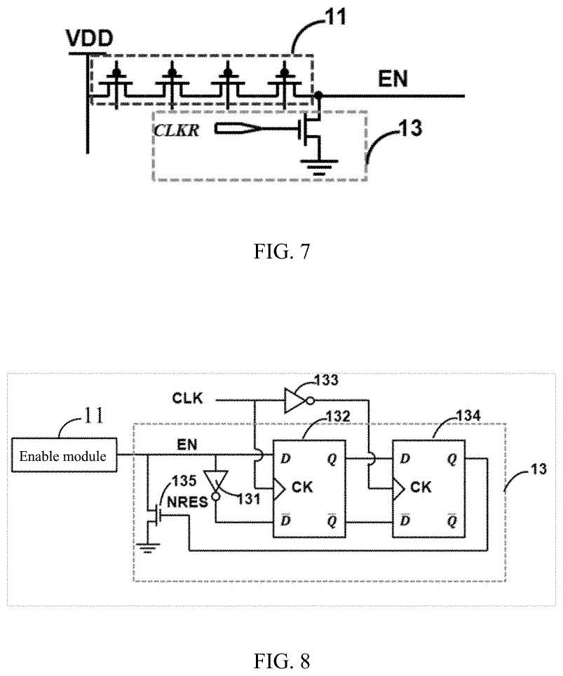

FIG. 7 is a circuit principle diagram of a first embodiment illustrating the reset module 13 according to the present disclosure. This embodiment is based on any row of the row decoder constituted by P-type transistors and the reset module 13 corresponding to this row.

As illustrated in FIG. 7, the reset module 13 may include a reset transistor.

A first electrode of the reset transistor is connected to the enable signal output terminal of the enable module 11, a second electrode of the reset transistor is connected to a ground signal (GND), and a gate of the reset transistor is connected to an external clock signal (CLKR). It should be noted herein that the external clock signal (CLKR) is an additional external clock signal. Further, this embodiment describes the row decoder constituted by the P-type transistors, and when the row decoder is constituted by the N-type transistors, the polarity is reverse to that of the row decoder constituted by the P-type transistors, which is not described herein any further.

FIG. 7 Exemplarily illustrates a row decoder constituted by the P-type transistors and a high level output by decoder.

As illustrated in FIG. 7, when a high pulse of the external clock signal (CLKR) comes in, the reset transistor is turned on, the output terminal of the row decoder is pulled down to a low level, and the output terminal of the row decoder is reset to the low level.

FIG. 8 is a circuit principle diagram of a second embodiment illustrating the reset module 13 according to the present disclosure. This embodiment is based on any row of the row decoder constituted by P-type transistors and the reset module 13 corresponding to this row.

As illustrated in FIG. 8, the reset module 13 includes a pull-down transistor 135, a first-stage positive edge flip-flop 132, a first-stage inverter 131, a second-stage positive edge flip-flop 134, and a second-stage inverter 133.

A non-inverting input terminal (D) of the first-stage positive edge flip-flop 132 and an input terminal of the first-stage inverter 131 are collectively connected to the enable signal output terminal of the enable module 11, an inverting input terminal of the first-stage positive edge flip-flop 132 is connected to an output terminal of the first-stage inverter 131, and a signal clock signal input terminal (CK) of the first-stage positive edge flip-flop 132 and an input terminal of the second-stage inverter 133 are collectively connected to an internal clock signal (CLK). A non-inverting input terminal (D) of the second-stage positive edge flip-flop 134 is connected to a non-inverting output terminal (Q) of the first-stage positive edge flip-flop 132, an inverting input terminal of the second-stage positive edge flip-flop 134 is connected to an inverting output terminal of the first-stage positive edge flip-flop 132, a clock signal input terminal of the second-stage positive edge flip-flop 134 is connected to an output terminal of the second-stage inverter 133, and a non-inverting output terminal (Q) of the second-stage positive edge flip-flop 134 is connected to a gate of the pull-down transistor 135. A first electrode of the pull-down transistor 135 is connected to the enable signal output terminal of the enable module 11, and a second electrode of the pull-down transistor 135 is connected to a ground signal (GND).

In this embodiment, the reset module 13 does not need to additionally reset the clock, and shares the same internal clock signal (CLK) and an inverting signal thereof with a latch at this stage.

As illustrated in FIG. 8, the reset module 13 according to this embodiment is constituted by two stages of cascaded positive edge flip-flops and inverters. The positive edge flip-flop is one of fundamental circuits in a digital logic circuit, and basically achieves the function of: storing a signal of the input terminal (D) only at a rising edge of an input clock and transmitting the signal to the output terminal (Q), and maintaining a signal of the output terminal (Q) unchanged at other times regardless of how the input terminal (D) changes. Based on this principle, the reset module 13 according to this embodiment operates based on the following principle: When the EN is selected and a high level is output, the high level is latched at the rising edge of the CLK, and transmitting the high level to the gate (NRES terminal) of the pull-down transistor 135 at a next falling edge of the CLK, the pull-down transistor 135 is turned on, and the EN is reset to a low level; and when the EN is not selected and a low level is output, the flip-flop has no output, the gate (NRES terminal) of the pull-down transistor 135 is constantly the low level, the pull-down transistor 135 is turned off, and the level of the EN is not affected.

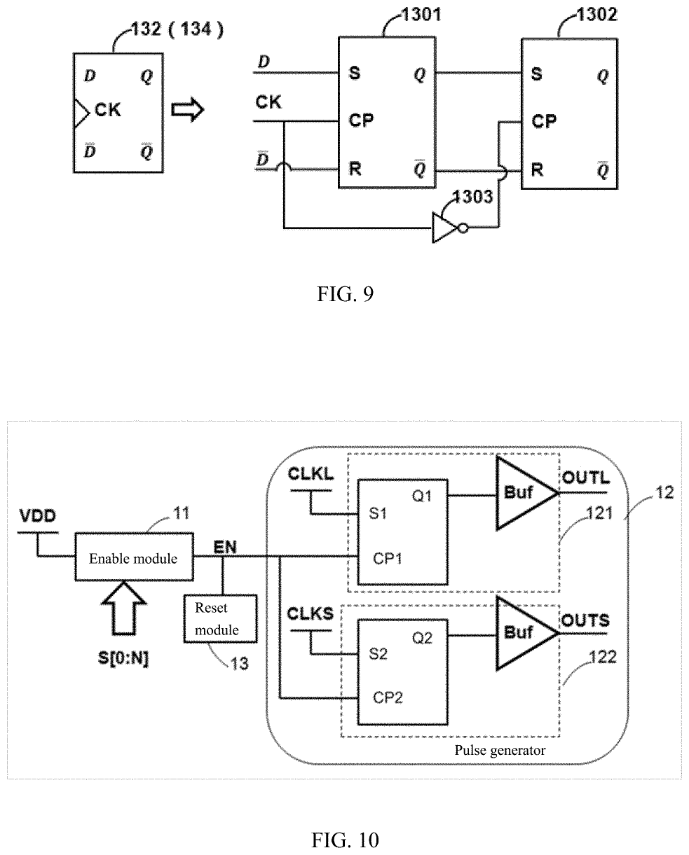

In the embodiments of the present disclosure, the positive edge flip-flop may be practiced in a plurality of ways, which is not specifically limited in the present disclosure. Description is given with reference to a specific embodiment. Specifically, as illustrated in FIG. 9, in this embodiment, the applied positive edge flip-flop may be a primary/secondary flip-flop, which may be constituted by two stages of latches.

As illustrated in FIG. 9, the first-stage positive edge flip-flop 132 and the second-stage positive edge flip-flop 134 both include a primary flip-flop 1301, a secondary flip-flop 1302, and a primary/secondary inverter 1303.

An input terminal (S) of the primary flip-flop 1301 is a non-inverting input terminal (D) of the positive edge flip-flop, a non-inverting output terminal of the primary flip-flop 1301 is connected to an input terminal (S) of the secondary flip-flop, a reset terminal (R) of the primary flip-flop is an inverting input terminal of the positive edge flip-flop, and an inverting output terminal of the primary flip-flop 1301 is connected to a reset terminal (R) of the secondary flip-flop 1302. A non-inverting output terminal (Q) of the secondary flip-flop 1302 is a non-inverting output terminal (Q) of the positive edge flip-flop, a clock signal input terminal (CP) of the secondary flip-flop 1302 is connected to an output terminal of the primary/secondary inverter 1303, and a connecting terminal between an input terminal of the primary/secondary inverter 1303 and a clock signal input terminal (CP) of the primary flip-flop 1301 is a clock signal input terminal (CK) of the positive edge flip-flop.

As illustrated in FIG. 10, the drive module 12 according to the embodiment of the present disclosure may include a pulse generator capable of simultaneously generating pulses having two different widths.

Two embodiments illustrating the pulse generator according to the present disclosure are described hereinafter.

FIG. 10 illustrates a first embodiment illustrating a pulse generator of a GOA circuit according to the present disclosure.

As illustrated in FIG. 10, a data input terminal of the pulse generator is connected to a clock signal, a clock input terminal of the pulse generator is connected to the enable signal output terminal of the enable module, and an output terminal of the pulse generator acts as the drive signal output terminal of the drive module 12 and is connected to the gate line of the row disposed corresponding to the drive module 12.

The pulse generator includes a first pulse generator 121 and a second pulse generator 122; and the clock signal includes a first clock signal (CLKL) and a second clock signal (CLKS). The gate line of the row disposed corresponding to the drive module 12 includes a first gate line of a row disposed corresponding to the first pulse generator 121 and a second gate line of a row disposed corresponding to the second pulse generator 122.

A data input terminal of the first pulse generator 121 is connected to the first clock signal (CLKL), a clock input terminal of the first pulse generator 121 is connected to the enable signal output terminal (EN) of the enable module 11, and an output terminal (OUTL) of the first pulse generator 121 is connected to the first gate line of the row disposed corresponding to the first pulse generator 121.

A data input terminal of the second pulse generator 122 is connected to the second clock signal (CLKS), a clock input terminal of the second pulse generator 122 is connected to the enable signal output terminal (EN) of the enable module 11, and an output terminal (OUTS) of the second pulse generator 122 is connected to the second gate line of the row disposed corresponding to the second pulse generator 122.

Herein, the data input terminal of the first pulse generator 121 and the data input terminal of the second pulse generator 122 form the data input terminal of the pulse generator, the clock input terminal of the first pulse generator 121 and the clock input terminal of the second pulse generator 122 form the clock input terminal of the pulse generator, and the output terminal of the first pulse generator 121 and the output terminal of the second pulse generator 122 form the output terminal of the pulse generator.

Further, as illustrated in FIG. 10, the first pulse generator 121 includes a first latch and a first buffer amplifier.

A first data input terminal (S1) of the first latch is connected to the first clock signal (CLKL), a first enable terminal (CP1) of the first latch is connected to the enable signal output terminal (EN) of the enable module 11, a first output terminal (Q1) of the first latch is connected to an input terminal of the first buffer amplifier, and an output terminal of the first buffer amplifier is connected to the first gate line of the row disposed corresponding to the first pulse generator 121. The first data input terminal (S1) of the first latch is the data input terminal of the first pulse generator 121, the first enable terminal (CP1) of the first latch is the clock input terminal of the first pulse generator 121, and the output terminal of the first buffer amplifier is the output terminal (OUTL) of the first pulse generator 121.

Further, as illustrated in FIG. 10, the second pulse generator 122 includes a second latch and a second buffer amplifier.

A second data input terminal (S2) of the second latch is connected to the second clock signal (CLKS), a second enable terminal (CP2) of the second latch is connected to the enable signal output terminal (EN) of the enable module 11, a second output terminal (Q2) of the second latch is connected to an input terminal of the second buffer amplifier, and an output terminal of the second buffer amplifier is connected to the second gate line of the row disposed corresponding to the second pulse generator 122.

The second data input terminal (S2) of the second latch is the data input terminal of the second pulse generator 122, the second enable terminal (CP2) of the second latch is the clock input terminal of the second pulse generator 122, and the output terminal of the second buffer amplifier is the output terminal (OUTS) of the second pulse generator 122.

In FIG. 10, each of the plurality of GOA units 10 includes a row decoder based on a P-type TFT (enable module 11), a reset module 13, a pulse generator (drive module 12). The pulse generator includes the first pulse generator 121 constituted by the first latch and the first buffer amplifier, and the second pulse generator 122 constituted by the second latch and the second buffer amplifier. In FIG. 10, VDD represents an input direct current high level, S[0:N] represents an input address signal, EN represents the enable signal output terminal of the enable module 11, the first clock signal (CLKL) represents an input long clock, the second clock signal (CLKS) represents an input short clock, Buf represents a buffer amplifier, OUTL represents the output terminal of the first pulse generator 121, and OUTS represents the output terminal of the second pulse generator 122.

Optionally, the latches employed in the embodiment of the present disclosure are all latches with a gate control function, which operate based on the following principle.

Using latches effective in case of a high level at the enable terminal as an example:

When the enable terminal potential of the latch is a low level, the output terminal of the latch remains unchanged, and a signal of the data input terminal of the latch does not affect the output terminal thereof.

When the enable terminal potential of the latch is a high level, a binary signal of the output terminal of the latch varies with an input potential of the data input terminal of the latch. It may be understood that the latch may be practiced in a plurality of ways, which is not specifically limited in the embodiments of the present disclosure. By employing the latch in each of the plurality of GOA units 10, the present disclosure may achieve the following advantages: Based on the latching principle, internal alternating current signals or glitch signals may be effectively suppressed from being coupled to the output terminal; and in addition, the latch has a waveform reconstruction function, and even if a waveform of an external clock is deformed due to an RC delay, upon the waveform reconstruction, a high-quality square wave pulse may be still output.

The most commonly used latch is an SR-type latch. Herein, two typical embodiments of the SR latch are described.

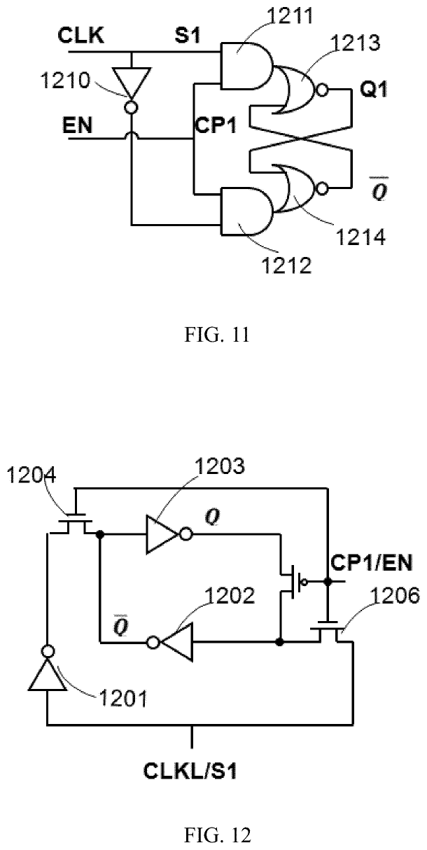

As illustrated in FIG. 11, in a specific embodiment, the first latch includes: a latch inverter 1210, a first AND gate 1211, a second AND gate 1212, a first NOR gate 1213, and a second NOR gate 1214.

An input terminal of the latch inverter 1210 and a first input terminal of the first AND gate 1211 are collectively connected to the internal clock signal (CLK), an output terminal of the latch inverter 1210 is connected to a second input terminal of the second AND gate 1212, and a second input terminal of the first AND gate 1211 and a first input terminal of the second AND gate 1212 are collectively connected to the enable signal output terminal (EN) of the enable module 11. An output terminal of the first AND gate 1211 is connected to a first input terminal of a first NOR gate 1213, a second input terminal of the first NOR gate 1213 is connected to a first input terminal of the second NOR gate 1214, and an output terminal of the first NOR gate 1213 is further connected to the input terminal of the buffer amplifier circuit 122. A second input terminal of the second NOR gate 1214 is connected to an output terminal of the second AND gate 1212.

A connecting terminal between the first input terminal of the first AND gate 1211 and the input terminal of the latch inverter 1210 is the first data input terminal of the first latch, a connecting terminal between the second input terminal of the first AND gate 1211 and the first input terminal of the second AND gate 1212 is the first enable terminal of the first latch, and the output terminal of the first NOR gate 1213 is the first output terminal of the first latch.

Likewise, the second latch may also employ the structure the same as the first latch. For details about the specific structure and connections, reference may be made to the above description, which are not described herein any further. Still likewise, a connecting terminal between the first input terminal of the first AND gate 1211 and the input terminal of the latch inverter 1210 is the second data input terminal of the second latch, a connecting terminal between the second input terminal of the first AND gate 1211 and the first input terminal of the second AND gate 1212 is the second enable terminal of the second latch, and the output terminal of the first NOR gate 1213 is the second output terminal of the second latch.

Further, as illustrated in FIG. 12, in a second specific embodiment of the latch, the first latch may include a first NOT gate 1201, a second NOT gate 1202, a third NOT gate 1203, a first transistor 1204, a second transistor 1205, and a third transistor 1206. Herein, the first transistor and the third transistor are N-type transistors, and the second transistor is a P-type transistor.

An input terminal of the first NOT gate 1201 is connected to a second electrode of the third transistor 1206, an output terminal of the first NOT gate 1201 is connected to a first electrode of the first transistor 1204, a second electrode of the first transistor 1204 is connected to an input terminal of the third NOT gate 1203 and an output terminal of the second NOT gate 1202, a third electrode of the first transistor 1204 is connected to a third electrode of the second transistor 1205 and a third electrode of the third transistor 1206, an output terminal of the third NOT gate 1203 is connected to a first electrode of the second transistor 1205, and a second electrode of the second transistor 1205 is connected to an input terminal of the second NOT gate 1202 and a first electrode of the third transistor 1206.

The input terminal of the first NOT gate 1201 and the second electrode of the third transistor 1206 are the first data input terminal of the first latch, the output terminal of the third NOT gate 1023 is the first output terminal of the first latch, and the third electrode of the first transistor 1204, the third electrode of the second transistor 1205, and the third electrode of the third transistor 1206 are the first enable terminal of the first latch.

In this embodiment, the second latch may also employ the structure the same as the first latch. For details about the specific structure and connections, reference may be made to the above description, which are not described herein any further. Likewise, the input terminal of the first NOT gate 1201 and the second electrode of the third transistor 1206 may also act as the first data input terminal of the second latch, the output terminal of the third NOT gate 1203 may also act as the second output terminal of the second latch, and the third electrode of the first transistor 1204, the third electrode of the second transistor 1205, and the third electrode of the third transistor 1206 may also act as the second enable terminal of the second latch. Likewise, herein, the first transistor and the third transistor are N-type transistors, and the second transistor is a P-type transistor.

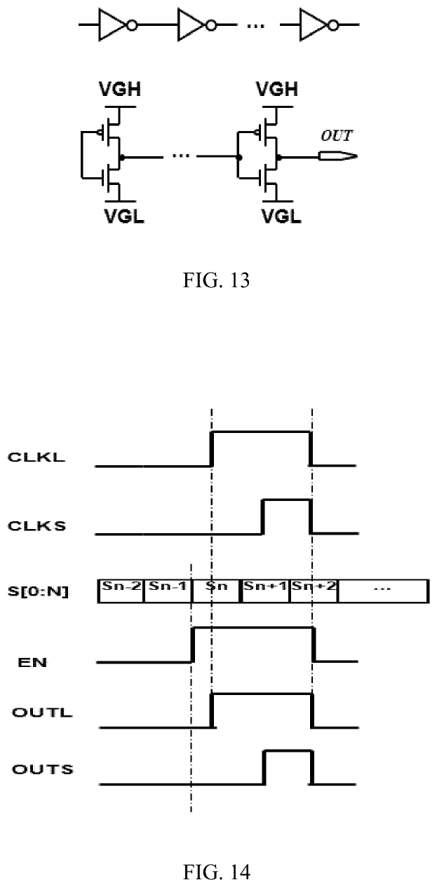

FIG. 13 illustrates a circuit principle diagram of a buffer amplifier according to an embodiment of the present disclosure.

The first buffer amplifier and the second buffer amplifier according to the embodiment of the present disclosure may be both constituted by two stages of inverters or a plurality of stages of cascaded inverters.

If the first buffer amplifiers has n stages, n being an odd number greater than or equal to 2, then the first data input terminal (S1) of the first latch is connected to the first clock signal (CLKL), the first enable terminal (CP1) of the first latch is connected to the enable signal output terminal (EN) of the enable module 11, the first output terminal (Q1) of the first latch is connected to an input terminal of a first-stage inverter, and an output terminal of an n^{th}-stage inverter acts as the output terminal (OUTL) of the first buffer amplifier and is connected to the first gate line of the row disposed corresponding to the first pulse generator 121.

If the second buffer amplifiers has n stages, n being an odd number greater than or equal to 2, then the second data input terminal (S2) of the second latch is connected to the second clock signal (CLKS), the second enable terminal (CP2) of the second latch is connected to the enable signal output terminal (EN) of the enable module 11, the second output terminal (Q2) of the second latch is connected to the input terminal of the first-stage inverter, and the output terminal of the n^{th}-stage inverter acts as the output terminal (OUTL) of the second buffer amplifier and is connected to the second gate line of the row disposed corresponding to the second pulse generator 122.

Further, the inverters employed in the plurality of stages of cascaded inverters in the embodiment of the present disclosure may be all constituted by transistors.

Specifically, as illustrated in FIG. 13, each inverter may include a P-type transistor and an N-type transistor.

Specifically, a first electrode of the P-type transistor is connected to a constant high voltage level (VGH), a second electrode of the P-type transistor is connected to a first electrode of the N-type transistor, a second electrode of the N-type transistor is connected to a constant low voltage level (VGL), a gate of the P-type transistor is connected to a gate of the N-type transistor, and the second electrode of the P-type transistor is connected to a first electrode of the N-type transistor.

The gate of the P-type transistor and the gate of the N-type transistor are the input terminal of the inverter, and the second electrode of the P-type transistor and the first electrode of the N-type transistor are the output terminal of the inverter.

It should be noted that in the embodiment of the present disclosure, a P-type transistor in each of the plurality of GOA units 10 is a P-channel thin film transistor made of low-temperature polysilicon, amorphous silicon, or a material resulted from a mixture of carbon, silicon, and germanium at any ratio. An N-type transistor in each of the plurality of GOA units 10 is an N-channel thin film transistor made of metal oxide. In addition, the GOA circuit according to the present disclosure is a GOA circuit based on polarity complementary transistors. That is, an N-type transistor and a P-type transistor are simultaneously disposed on a panel.

Referring to FIG. 14, an operating timing of a first embodiment (that is, the circuit diagram in FIG. 10) illustrating an employed pulse generator is illustrated.

As illustrated in FIG. 14, a row address signal is input to activate the decoder, and EN rises; and during the period where the EN output is a high level, the first latch and the second latch are turned on, and a first pulse signal and a second pulse signal are output. The first pulse signal is a long pulse signal, and the second pulse signal is a short pulse signal. The reset module 13 is activated, EN falls, the first latch and the second latch are turned off, and no pulse is output.

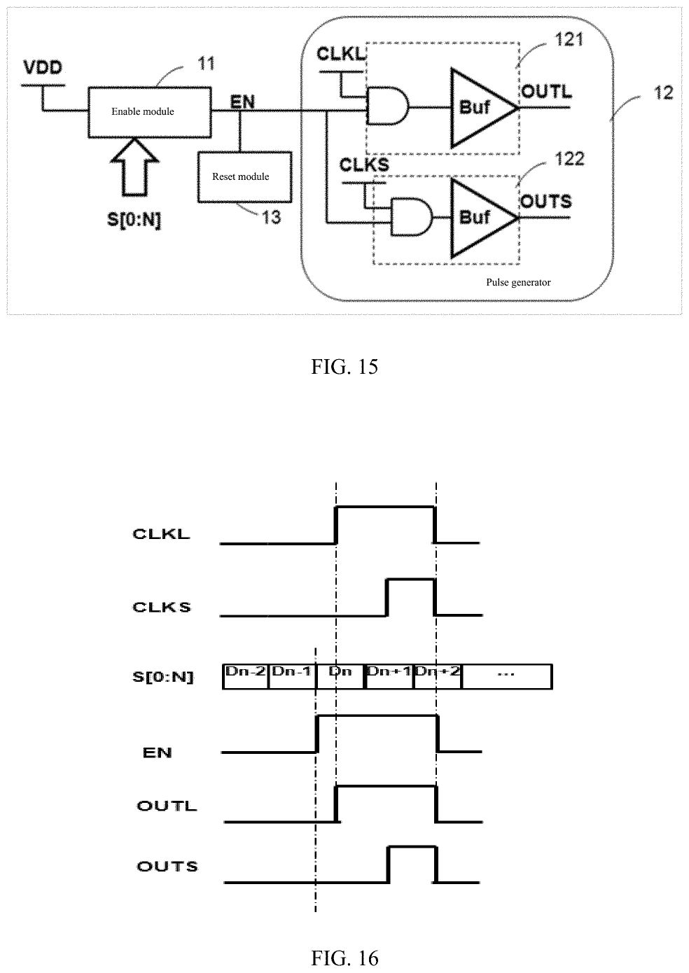

FIG. 15 illustrates a circuit principle diagram of a second embodiment illustrating a pulse generator employed by the GOA circuit according to the present disclosure.

As illustrated in FIG. 15, in this embodiment, the first pulse generator 121 includes a first-stage AND gate and a first buffer amplifier.

A first input terminal of the first-stage AND gate is connected to the first clock signal (CLKL), a second input terminal of the first-stage AND gate is connected to the enable signal output terminal (EN) of the enable module 11, an output terminal of the first-stage AND gate is connected to an input terminal of the first buffer amplifier, and an output terminal of the first buffer amplifier is connected to the first gate line of the row disposed corresponding to the first pulse generator 121. The first input terminal of the first-stage AND gate is the data input terminal of the first pulse generator 121, the second input terminal of the first-stage AND gate is the clock input terminal of the first pulse generator 121, and the output terminal of the first buffer amplifier is the output terminal (OUTL) of the first pulse generator 121.

The second pulse generator 122 includes a second-stage AND gate and a second buffer amplifier.

A first input terminal of the second-stage AND gate is connected to the second clock signal (CLKS), a second input terminal of the second-stage AND gate is connected to the enable signal output terminal (EN) of the enable module 11, an output terminal of the second-stage AND gate is connected to an input terminal of the second buffer amplifier, and an output terminal of the second buffer amplifier is connected to the second gate line of the row disposed corresponding to the second pulse generator 122. The first input terminal of the second-stage AND gate is the data input terminal of the second pulse generator 122, the second input terminal of the second-stage AND gate is the clock input terminal of the second pulse generator 122, and the output terminal of the second buffer amplifier is the output terminal (OUTS) of the second pulse generator 122.

As illustrated in FIG. 15, in this embodiment, each of the plurality of GOA units 10 includes a row decoder based on a P-type TFT (the enable module 11), a reset module 13, a pulse generator (the drive module 12). The pulse generator includes the first pulse generator 121 constituted by the first-stage AND gate and the first buffer amplifier, and the second pulse generator 122 constituted by the second-stage AND gate and the second buffer amplifier. In a specific embodiment, the AND gate may be replaced by a NAND gate plus an inverter, wherein the inverter is incorporated into the buffer amplifier; or in some other embodiments, the AND gate may also be replaced by an inverter plus a NOR gate. In this embodiment, a simple logic gate circuit replaces the latch used in the first embodiment.

FIG. 16 illustrates an operating timing of a GOA circuit employing the pulse generator in FIG. 15.

As illustrated in FIG. 16, an address signal is input to activate the decoder, and EN rises; during the period where the EN output is a high level, the first-stage AND gate and the second-stage AND gate are turned on, and a first pulse signal and a second pulse signal are output; the reset module 13 is activated, EN falls, the first-stage AND gate and the second-stage AND gate are turned off, and no pulse is output.

As described above, various components (the reset module 13, the latch, and the pulse generator) of the GOA circuit according to the embodiment of the present disclosure may have various embodiments. A plurality of possible circuit practice schemes may be reached by arranging and combining the embodiments of the various components. In addition, by these different schemes, a compromise may be made between the area, power consumption, reliability, anti-interference capability, and waveform quality.

Three complete schemes are described hereinafter, and corresponding cascading schemes and timings are provided. In addition, a comparison between a simulation verification result and an operating timing is further provided.

For simplification of the circuit principle diagram, the principle diagram according to the embodiments of the present disclosure only uses a 4-bit address as an example (in this case, the decoder only includes four transistors). The simulation uses an 8-bit address as an example (the address bus is represented by S[0:N]). It should be noted that in practice, the address may be extended to more bits.

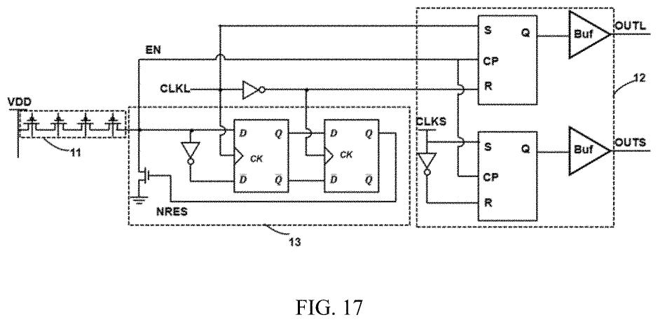

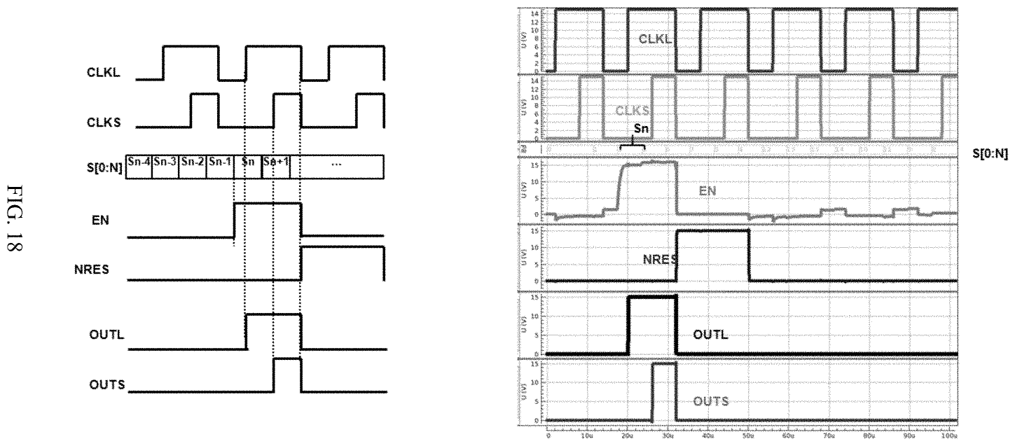

FIG. 17 illustrates a schematic diagram of a first GOA circuit according to an embodiment of the present disclosure.

In this embodiment, the reset module 13 employs the circuit as described in the second embodiment, and the pulse generator employs the circuit as described in the first embodiment. A single-stage operating timing and a simulation timing are as illustrated in FIG. 18. As illustrated in FIG. 18, verification results of a theoretical operating timing and the simulation timing are equivalent.

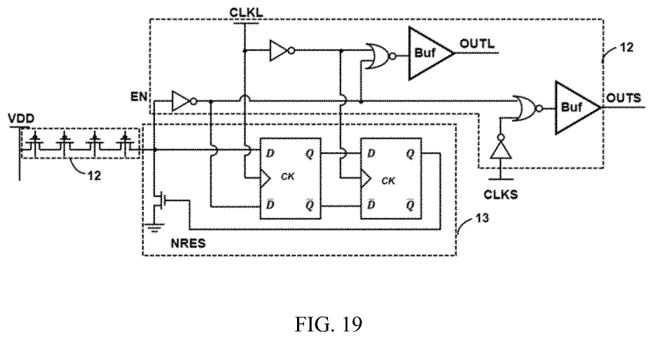

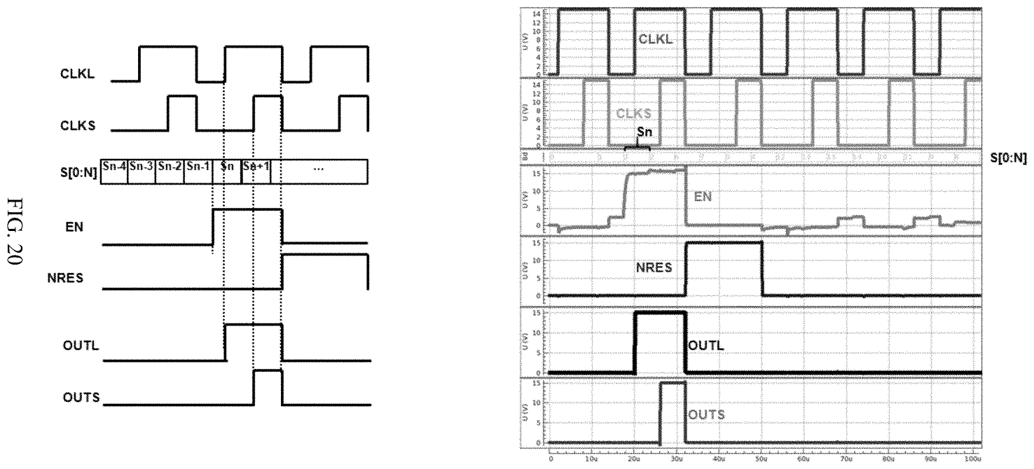

FIG. 19 illustrates a principle diagram of a second GOA circuit according to an embodiment of the present disclosure.

In this embodiment, the reset module 13 employs the circuit as described in the second embodiment, and the pulse generator employs the circuit as described in the second embodiment. As described above, when the pulse generator according to this embodiment employs the circuit as described in the second embodiment, the AND gate in the initial principle diagram may be replaced by a NOT gate and a NOR gate. It may be understood that in some embodiments, in some processes, the NOR gate may achieve a better circuit performance over the AND gate and the NAND gate, or occupy an even smaller area. A single-stage operating timing and a simulation timing are as illustrated in FIG. 20. As illustrated in FIG. 20, a timing of key nodes in this embodiment is consistent with the timing of the first GOA circuit in FIG. 17, and as compared with the embodiment as illustrated in FIG. 17, in this embodiment, the occupied circuit area is small, and fewer transistors are used.

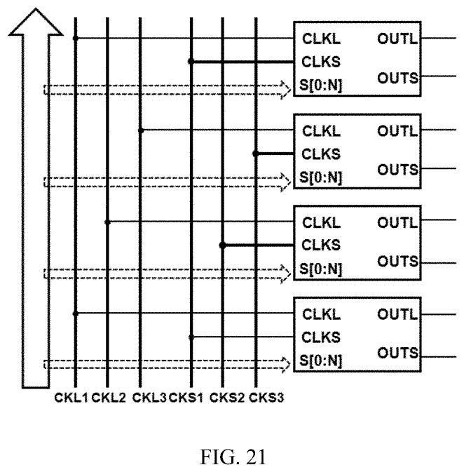

FIG. 21 illustrates a schematic diagram of cascading of a first GOA circuit and a second GOA circuit according to an embodiment of the present disclosure.

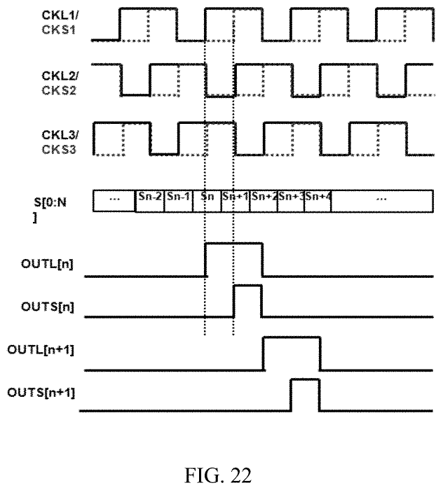

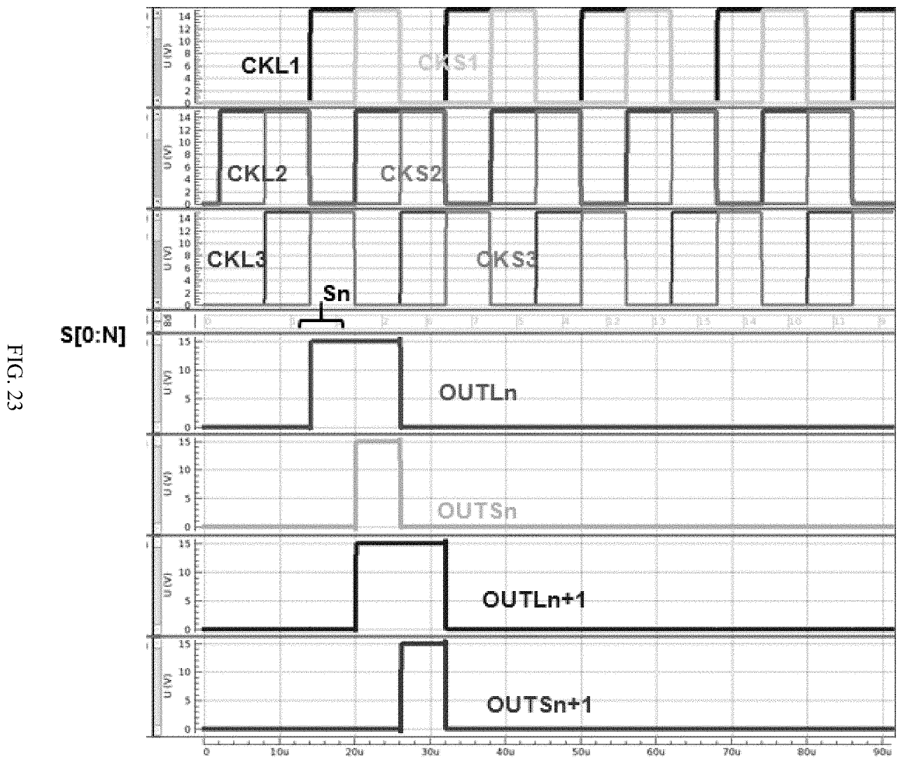

FIG. 22 illustrates a global timing of cascading of the first GOA circuit in FIG. 17, and FIG. 23 illustrates a simulation of the global timing of the cascading of the first GOA circuit in FIG. 17. As seen from a comparison between FIG. 22 and FIG. 23, the global operating timing of cascading of the first GOA circuit in FIG. 17 and the simulation timing are equivalent.

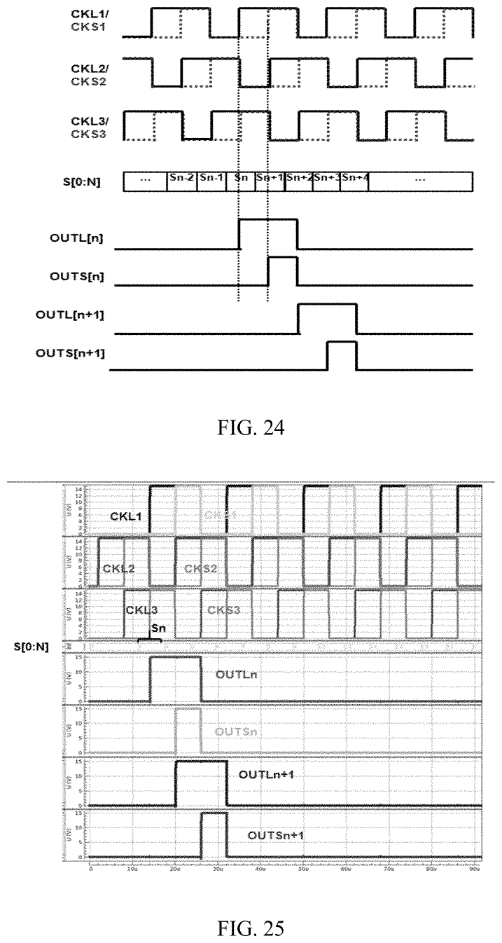

FIG. 24 is a global timing of cascading of the second GOA circuit in FIG. 19 according to the present disclosure, and FIG. 25 is a simulation timing thereof. As illustrated in FIG. 24 and FIG. 25, the global input and the output waveform of the circuit are both substantially the same as those in FIG. 22 and FIG. 23 regardless of in the principle diagram and the simulation diagram.

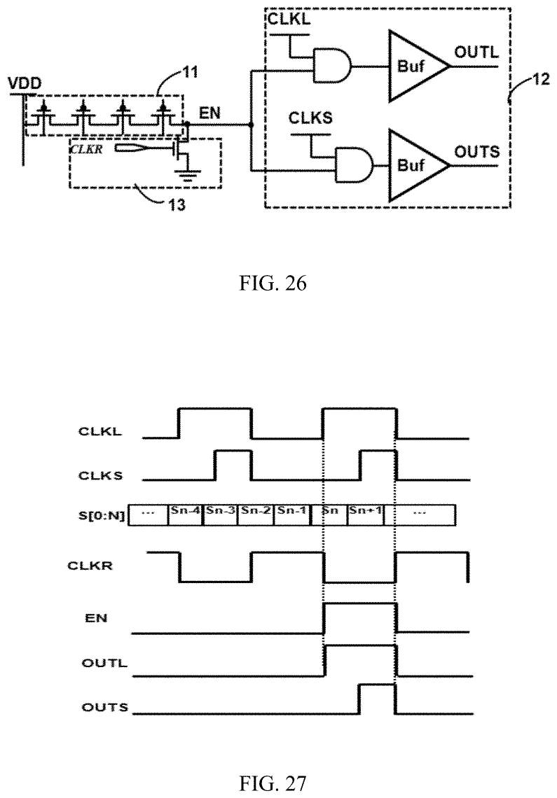

FIG. 26 illustrates a schematic diagram of a third GOA circuit according to an embodiment of the present disclosure.

In this embodiment, the reset module 13 employs the circuit as described in the second embodiment, and the pulse generator employs the circuit as described in the second embodiment. As compared with the second GOA circuit in FIG. 20, in this embodiment, fewer transistors are used, and the occupied circuit area is smaller.

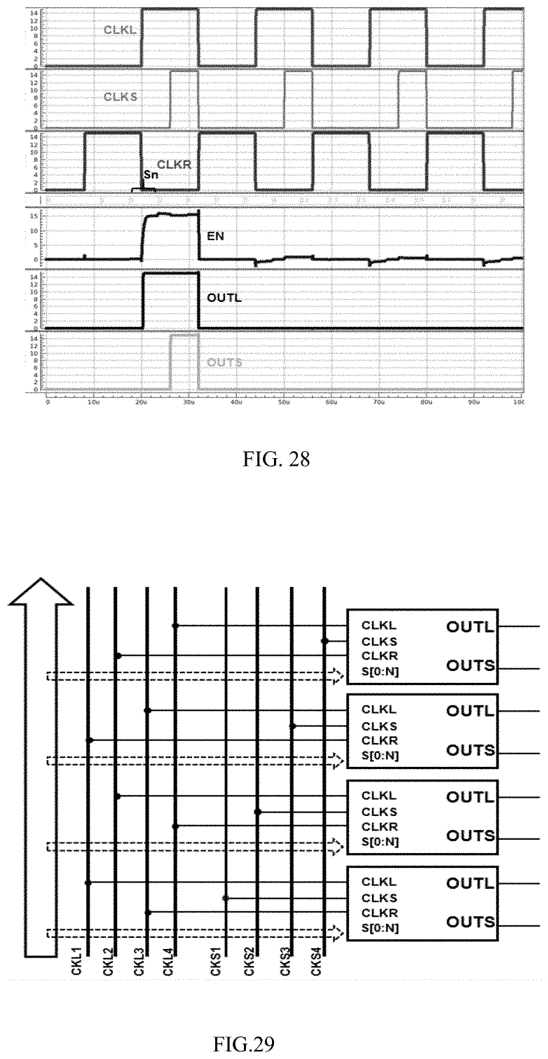

Referring to FIG. 27, a single-stage timing of the GOA circuit in FIG. 26 is illustrated. Herein, the case where a minimum number of clocks are globally used is illustrated. A simulation timing is as illustrated in FIG. 28. As illustrated in FIG. 28, the operating timing and the simulation timing are equivalent.

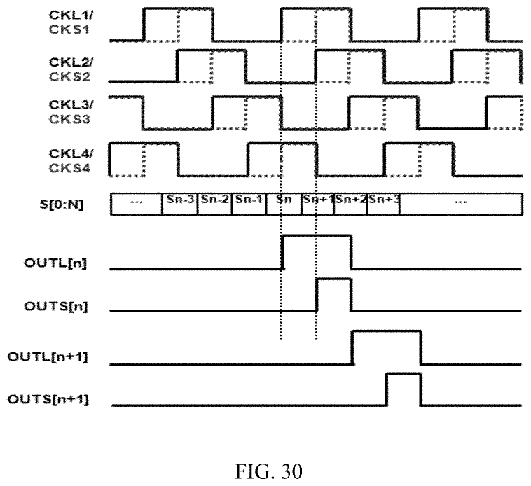

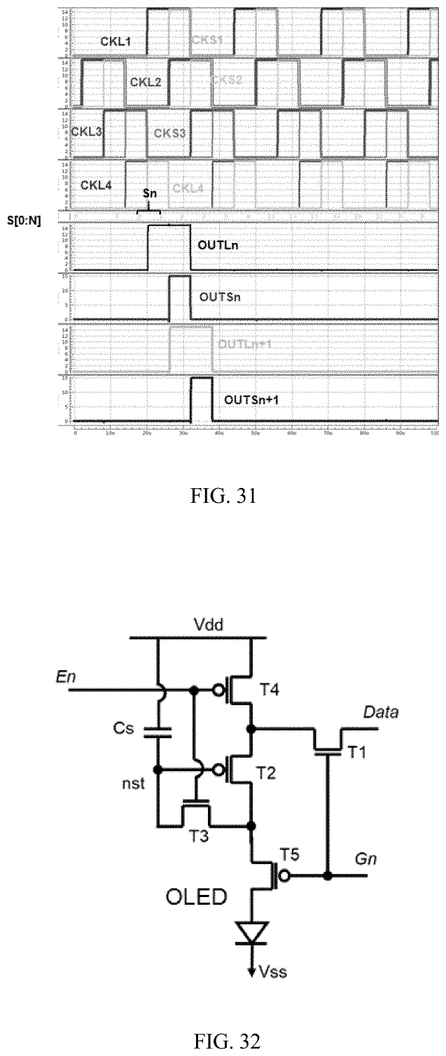

FIG. 29 is a schematic diagram of cascading of a third GOA circuit according to an embodiment of the present disclosure. A global timing and a simulation timing are as illustrated in FIG. 30 and FIG. 31 respectively. As seen from a comparison between FIG. 30 and FIG. 31, the operating timing and the simulation timing are equivalent.

The present disclosure provides a GOA circuit supporting random addressing. The GOA circuit allows data to be written into the screen not in accordance with rows. A majority region of the screen displays static images and only a small portion of the screen is constantly varying, and only this portion needs to be programmed. In addition, since the rows with static images are not gated, and thus dynamic power consumption is effectively reduced and meanwhile the time left for each row with varying images, such that real-time and dynamic adjustment may be achieved between display size, display power and display refresh rate.

Further, in the GOA circuit according to the present disclosure, trigger of a later stage does not rely on trigger of a previous stage. Therefore, when a separated-stage GOA unit fails, functions of the remaining GOA units are not affected, such that rating of the screen are improved, thereby providing possibilities of dynamic repair of the screen. In addition, the GOA circuit according to the present disclosure does not employ a traditional bootstrap structure. In some embodiments, a clock line does not need to directly drive an output transistor in the GOA unit. Therefore, impacts caused by (N−1) stages of inactive GOA units to the dynamic power consumption may be greatly mitigated. Therefore, the GOA circuit according to the present disclosure is applicable to high-resolution and large-size screens.

Further, with the GOA circuit according to the present disclosure, the pixel circuit in the display circuit of the display panel achieves the following merits: The high-drive P-type transistor provides a sufficient light-emitting current and saves the pixel area; the low-drain current N-type transistor maintains voltage data complete, and allows a variable fresh rate; the input drive waveform is simple, and the requirement on the storage capacitor is not high; the light-emitting current is substantially determined by the drive transistor, and is insensitive to OLED aging; the pixel circuit has the internal compensation function, and is capable of compensating for the temporary or permanent fluctuations of the threshold voltage of the high-drive P-type transistor caused by process fluctuations, electrical pressure, material aging, or mechanical stress, such that the life time of the screen is prolonged and the uniformity of the screen is improved.

Further, with the pulse generator according to the above embodiment, the GOA circuit according to the embodiments of the present disclosure is capable of generating long and short pulse signals configured to drive pixels in various rows, and may be directly cooperated with the pixel circuit. As compared with the conventional GOA circuit only capable of supplying scanning pulses having a single width, the GOA circuit according to the embodiments of the present disclosure is capable of supplying scanning pulses having two different widths that are desired by the pixel circuit having the internal compensation function, without increasing a bezel area and power consumption.

As illustrated in FIG. 32, the present disclosure further provides a pixel circuit having an internal compensation effect that is in cooperation with the GOA circuit.

FIG. 32 is a circuit principle diagram of a first embodiment illustrating a pixel circuit having an internal compensation effect according to the present disclosure.

As illustrated in FIG. 32, the pixel circuit includes a first transistor T1, a second transistor T2, a third transistor T3, a fourth transistor T4, a fifth transistor T5, a capacitor Cₛ, a node (nst), and a light-emitting unit (OLED).

A second electrode of the first transistor T1 is connected to a data signal (Data), a first electrode of the first transistor T1 is connected to a second electrode of the fourth transistor T4 and a first electrode of the second transistor T2, a third electrode of the first transistor T1 and a third electrode of the fifth transistor T5 are connected to a second output terminal of the drive module 12; a first electrode of the fourth transistor T4 is connected to a high level (Vdd), a third electrode of the fourth transistor T4 and a third electrode of the third transistor T3 are connected to a first output terminal of the drive module 12, a second electrode of the second transistor T2 and a second electrode of the third transistor T3 are collectively connected to a first electrode of the fifth transistor T5, a second electrode of the fifth transistor T5 is connected to a positive electrode of the light-emitting unit (OLED), and a negative electrode of the light-emitting unit (OLED) is connected to a low level (Vss); and a first electrode of the third transistor T3 is connected in sequence to the node (nst) and the capacitor Cₛ and then connected to the high level (Vdd), and the node (nst) is further connected to a third electrode of the second transistor T2.

The third electrode of the fourth transistor T4 and the third electrode of the third transistor T3 are the first gate line of the row disposed corresponding to the first pulse generator 121, and the third electrode of the first transistor T1 and the third electrode of the fifth transistor T5 are the second gate line of the row disposed corresponding to the second pulse generator 122. The first output terminal of the first pulse generator 121 is the first output terminal of the drive module 12, and the second output terminal of the second pulse generator 122 is the second output terminal of the drive module 12.

As illustrated in FIG. 10 or FIG. 15, the first pulse signal (En) output by the first output terminal of the first pulse generator 121 is a long pulse signal, and the second pulse signal (Gn) output by the second output terminal of the second pulse generator 122 is a short pulse signal. That is, a high-level pulse width of the first pulse signal (En) is greater than a high-level pulse width of the second pulse signal (Gn).

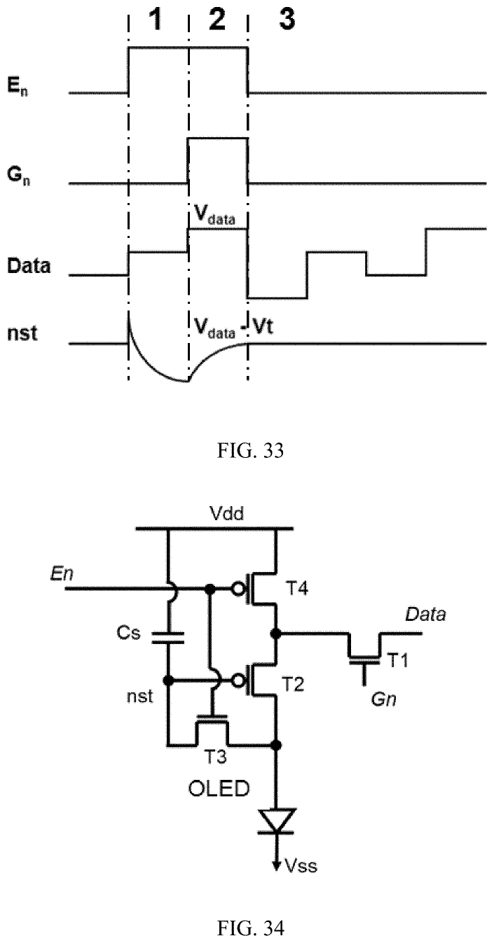

Further, an operating timing of the pixel circuit practiced by five transistors and one capacitor (that is, 5T1C) is as illustrated in FIG. 33. Hereinafter, the operating process of the circuit according to this embodiment is described with reference to FIG. 33.

At a first stage, when the first pulse signal (En) output by the first pulse generator 121 is a high level, and the second pulse signal (Gn) output by the second pulse generator 122 is a low level, the first transistor T1 and the fourth transistor T4 are turned off, the third transistor T3 and the fifth transistor T5 are turned on, and the node (nst) is discharged to a low level (Vss) via the third transistor T3, the fifth transistor T5, and the light-emitting unit (OLED).

At a second stage, the first transistor T1 is turned on, the data signal (Data) charges the node (nst) via the second transistor T2 and the third transistor T3, and the voltage of the node (nst) is terminated at Vdata−Vt, to sample a threshold voltage of the second transistor T2. Vt is the threshold voltage of the second transistor.

At a third stage, the fourth transistor T4, the second transistor T2, and the fifth transistor T5 are turned on, and the first transistor T1 and the third transistor T3 are turned off. The light-emitting unit (OLED) emits light, the voltage (Vgs) of the second transistor T2 is (Vdd−Vdata+Vt), and thus a compensation effect for Vt is achieved.

Alternatively, in another embodiment, as illustrated in FIG. 34, the pixel circuit in cooperation with the GOA circuit according to the present disclosure includes a first transistor T1, a second transistor T2, a third transistor T3, a fourth transistor T4, a capacitor Cs, a node (nst), and a light-emitting unit (OLED).

A second electrode of the first transistor T1 is connected to a data signal (Data), a first electrode of the first transistor T1 is connected to a second electrode of the fourth transistor T4 and a first electrode of the second transistor T2, a third electrode of the first transistor T1 is connected to a second output terminal of the second pulse generator 122; a first electrode of the fourth transistor T4 is connected to a high level (Vdd), a third electrode of the fourth transistor T4 and a third electrode of the third transistor T3 are connected to a first output terminal of the first pulse generator 121, a second electrode of the second transistor T2 and a second electrode of the third transistor T3 are collectively connected to a positive electrode of the light-emitting unit (OLED), and a negative electrode of the light-emitting unit (OLED) is connected to a low level (Vss); and a first electrode of the third transistor T3 is connected in sequence to the node (nst) and the capacitor Cs and then connected to the high level (Vdd), and the node (nst) is further connected to a third electrode of the second transistor T2.

The third electrode of the fourth transistor T4 and the third electrode of the third transistor T3 are the first gate line of the row disposed corresponding to the first pulse generator 121, and the third electrode of the first transistor T1 is the second gate line of the row disposed corresponding to the second pulse generator 122.

In the second embodiment of the pixel circuit, the pixel circuit is practiced by four transistors and one capacitor (that is, 4T1C). A specific operating timing is as illustrated in FIG. 33. The operating process of the circuit in this embodiment is the same as that in the above embodiment, which is not described herein any further.

Further, in the pixel circuit according to the embodiment of the present disclosure, the first transistor T1 and the third transistor T3 are N-type transistors, and the second transistor T2, the fourth transistor T4, and the fifth transistor T5 are P-type transistors. A P-type transistor in each pixel circuit is a P-channel thin film transistor made of low-temperature polysilicon, amorphous silicon, or a material resulted from a mixture of carbon, silicon, and germanium at any ratio. An N-type transistor in each pixel circuit is an N-channel thin film transistor made of metal oxide.

The pixel circuit in the display device according to the present disclosure achieves the following merits: The high-drive P-type transistor provides a sufficient light-emitting current and saves the pixel area; the low-drain current N-type transistor maintains voltage data complete, and allows a variable fresh rate; the input drive waveform is simple, and the requirement on the storage capacitor is not high; the light-emitting current is substantially determined by the drive transistor, and is insensitive to OLED aging; the pixel circuit has the internal compensation function, and is capable of compensating for the temporary or permanent fluctuations of the threshold voltage of the high-drive P-type transistor caused by process fluctuations, electrical pressure, material aging, or mechanical stress, such that the life time of the screen is prolonged and the uniformity of the screen is improved.

Further, the present disclosure further provides a display device. The display device includes the GOA circuit as described in the above embodiment and a pixel circuit having an internal compensation effect. The display device includes, but is not limited to, an LTPS display device and an AMOLED display device.

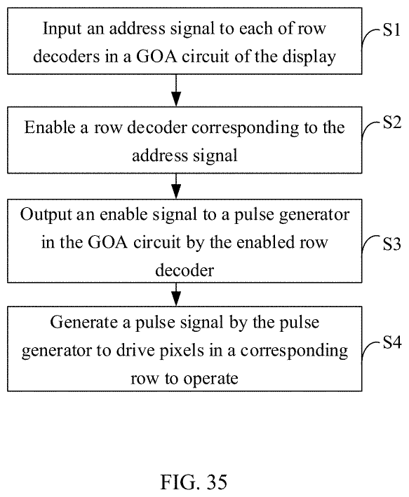

FIG. 35 is a schematic flowchart of a method for driving a display according to an embodiment of the present disclosure. As illustrated in FIG. 35, the method may include the following steps:

step S1, inputting an address signal to each of row decoders in a GOA circuit of the display;

step S2, enabling a row decoder corresponding to the address signal;

step S3,outputting an enable signal to a pulse generator in the GOA circuit by the enabled row decoder; and

step S4, generating a pulse signal by the pulse generator to drive pixels in a corresponding row to operate.

In the embodiment of the present disclosure, the GOA circuit in the method for driving the display may be the GOA circuit as described in the above embodiment.

Further, in the embodiment of the present disclosure, the pulse generator respectively generates a short pulse signal and a long pulse signal, to respectively drive pixels in different rows to operate. That is, the GOA circuit according to the embodiment of the present disclosure is capable of simultaneously generating pulse signals having two widths. It may be understood that the short pulse signal herein is the second pulse signal as described above, and the long pulse signal is the first pulse signal as described above.

Further, the pulse generator further receives the long clock signal and the short clock signal, and generates the long pulse signal and the short pulse signal based on the long clock signal and the short clock signal. It may be understood that the long clock signal herein is the first clock signal (CLKL) as described above, and the short clock signal herein is the second clock signal (CLKS) as described above.

In the embodiment of the present disclosure, the pulse generator may include a first pulse generator and a second pulse generator; wherein the long clock signal is input to a data input terminal of the first pulse generator, the short clock signal is input to a data input terminal of the second pulse generator, and the enable signal is input to a clock input terminal of the first pulse generator and a clock input terminal of the second pulse generator.

Further, the method according to the embodiment of the present disclosure further includes: resetting the enable signal output by the enabled row decoder. Further, resetting the enable signal output by the enabled row decoder may be performed by the reset circuit.

Further, the method for driving the display according to the embodiment of the present disclosure further includes: inputting a long clock signal or a short clock signal to the reset circuit; and resetting, by the reset circuit, the enable signal based on the long clock signal or the short clock signal.

The above embodiments are merely given for illustration of the technical concepts and characteristics of the present disclosure, and are intended to better help persons skilled in the art to understand the content of the present disclosure and practice the technical solutions according to the present disclosure. However, these embodiments are not intended to limit the protection scope of the present disclosure. Any equivalent modifications and polishments made within the protection scope of the appended claims shall be all within the protection scope subject to the appended claims.

It should be understood that persons of ordinary skill in the art may derive improvements or variations according to the above description, and such improvements or variations shall all fall within the protection scope as defined by the claims of the present disclosure.

What is claimed is:

1. A gate driver on array (GOA) circuit, comprising a plurality of GOA units independent of each other, wherein each of the plurality of GOA units comprises an enable module and a drive module disposed corresponding to the enable module; wherein
the enable module includes an address input terminal configured to receive a row address signal, and an enable signal output terminal configured to output an enable signal based on the row address signal; and
the drive module comprises an enable signal input terminal configured to receive the enable signal output by the enable signal output terminal, and a drive signal output terminal configured to output drive signals having different pulse widths based on the enable signal, wherein the drive signal output terminal is connected to a gate line of a row disposed corresponding to the drive module to transmit the drive signal to the gate line of the row and gate the row.

2. The GOA circuit according to claim 1, wherein the enable module is a row decoder based on binary coding or a row decoder based on Gray coding.

3. The GOA circuit according to claim 2, wherein each row decoder comprises a plurality of transistors connected in series, two transistors in adjacent rows and in a same column being combined to a transistor when satisfying a preset condition.

4. The GOA circuit according to claim 3, wherein the two transistors in adjacent rows and in the same column satisfying the preset condition comprises
gates of the two transistors being shorted together, and each of the two transistors being an uppermost transistor in the row decoder; or gates of the two transistors being shorted together, and upper transistors adjacent to the two transistors having been combined.

5. The GOA circuit according to claim 1, wherein each of the plurality of GOA units further comprises a reset module connected to the enable signal output terminal of the enable module and configured to reset the enable module in response to the drive module outputting the drive signal and gating the corresponding row.

6. The GOA circuit according to claim 5, wherein the reset module comprises a reset transistor;
wherein a first electrode of the reset transistor is connected to the enable signal output terminal of the enable module, a second electrode of the reset transistor is connected to a ground signal, and a gate of the reset transistor is connected to an external clock signal.

7. The GOA circuit according to claim 5, the reset module comprises a pull-down transistor, a first-stage positive edge flip-flop, a first-stage inverter, a second-stage positive edge flip-flop, and a second-stage inverter; wherein
an positive input terminal of the first-stage positive edge flip-flop and an input terminal of the first-stage inverter are collectively connected to the enable signal output terminal of the enable module, an inverting input terminal of the first-stage positive edge flip-flop is connected to an output terminal of the first-stage inverter, and both a clock signal input terminal of the first-stage positive edge flip-flop and an input terminal of the second-stage inverter are collectively connected to an internal clock signal;
an positive input terminal of the second-stage positive edge flip-flop is connected to a positive output terminal of the first-stage positive edge flip-flop, an inverting input terminal of the second-stage positive edge flip-flop is connected to an inverting output terminal of the first-stage positive edge flip-flop, a clock signal input terminal of the second-stage positive edge flip-flop is connected to an output terminal of the second inverter, and a positive output terminal of the second-stage positive edge flip-flop is connected to a gate of the pull-down transistor; and
a first electrode of the pull-down transistor is connected to the enable signal output terminal of the enable module, and a second electrode of the pull-down transistor is connected to a ground signal.

8. The GOA circuit according to claim 7, wherein both the positive edge flip-flop in the first stage, and the positive edge flip-flop in the second stage comprise a primary flip-flop, a secondary flip-flop, and a primary/secondary inverter; wherein
an input terminal of the primary flip-flop is a positive input terminal of a positive edge flip-flop, a positive output terminal of the primary flip-flop is connected to an input terminal of the secondary flip-flop, a reset terminal of the primary flip-flop is an inverting input terminal of the positive edge flip-flop, and an inverting output terminal of the primary flip-flop is connected to a reset terminal of the secondary flip-flop; and
a positive output terminal of the secondary flip-flop is a positive output terminal of the positive edge flip-flop, an inverting output terminal of the secondary flip-flop is an inverting output terminal of the positive edge flip-flop, a clock signal input terminal of the secondary flip-flop is connected to an output terminal of the primary/secondary inverter, an input terminal of the primary/secondary inverter and a clock signal input terminal of the primary flip-flop are a clock signal input terminal of the positive edge flip-flop.

9. The GOA circuit according to claim 1, wherein the drive module comprises a pulse generator;
wherein a data input terminal of the pulse generator is connected to a clock signal, a clock input terminal of the pulse generator is connected to the enable signal output terminal of the enable module, and an output terminal of the pulse generator acts as the drive signal output terminal of the drive module and is connected to the gate line of the row disposed corresponding to the drive module.

10. The GOA circuit according to claim 9, wherein the pulse generator comprises a first pulse generator and a second pulse generator; the clock signal comprises a first clock signal and a second clock signal; the gate line of the row disposed corresponding to the drive module comprises a first gate line of a row disposed corresponding to the first pulse generator and a second gate line of a row disposed corresponding to the second pulse generator;
wherein a data input terminal of the first pulse generator is connected to the first clock signal, a clock input terminal of the first pulse generator is connected to the enable signal output terminal of the enable module, and an output terminal of the first pulse generator is connected to the first gate line of the row disposed corresponding to the first pulse generator; and
wherein a data input terminal of the second pulse generator is connected to the second clock signal, a clock input terminal of the second pulse generator is connected to the enable signal output terminal of the enable module, and an output terminal of the second pulse generator is connected to the second gate line of the row disposed corresponding to the second pulse generator.

11. The GOA circuit according to claim 10, wherein the first pulse generator comprises a first latch and a first buffer amplifier; wherein
a first data input terminal of the first latch is connected to the first clock signal, a first enable terminal of the first latch is connected to the enable signal output terminal of the enable module, a first output terminal of the first latch is connected to an input terminal of the first buffer amplifier, and an output terminal of the first buffer amplifier is connected to the first gate line of the row disposed corresponding to the first pulse generator; and
the first data input terminal of the first latch is the data input terminal of the first pulse generator, the first enable terminal of the first latch is the clock input terminal of the first pulse generator, and the output terminal of the first buffer amplifier is the output terminal of the first pulse generator.

12. The GOA circuit according to claim 11, wherein the second pulse generator comprises a second latch and a second buffer amplifier; wherein
a second data input terminal of the second latch is connected to the second clock signal, a second enable terminal of the second latch is connected to the enable signal output terminal of the enable module, a second output terminal of the second latch is connected to an input terminal of the second buffer amplifier, and an output terminal of the second buffer amplifier is connected to the second gate line of the row disposed corresponding to the second pulse generator; and
the second data input terminal of the second latch is the data input terminal of the second pulse generator, the second enable terminal of the second latch is the clock input terminal of the second pulse generator, and the output terminal of the second buffer amplifier is the output terminal of the second pulse generator.

13. The GOA circuit according to claim 12, wherein the first latch and the second latch both comprise a latch inverter, a first AND gate, a second AND gate, a first NOR gate, and a second NOR gate; wherein
an input terminal of the latch inverter is connected to a first input terminal of the first AND gate, an output terminal of the latch inverter is connected to a second input terminal of the second AND gate, and a second input terminal of the first AND gate is connected to a first input terminal of the second AND gate;
an output terminal of the first AND gate is connected to a first input terminal of the first NOR gate, a second input terminal of the first NOR gate is connected to an output terminal of the second NOR gate, an output terminal of the first NOR gate is connected to a first input terminal of the second NOR gate, and a second input terminal of the second NOR gate is connected to an output terminal of the second AND gate;
the first data input terminal of the first latch and the second data input terminal of the second latch are both a connecting terminal between the first input terminal of the first AND gate and the input terminal of the latch inverter;
the first output terminal of the first latch and the second output terminal of the second latch are both the output terminal of the first NOR gate; and
the first enable terminal of the first latch and the second enable terminal of the second latch are both a connecting terminal between the second input terminal of the first AND gate and the first input terminal of the second AND gate.

14. The GOA circuit according to claim 13, wherein the first latch and the second latch both comprise a first NOT gate, a second NOT gate, a third NOT gate, a first transistor, a second transistor, and a third transistor; wherein the first transistor and the third transistor are N-type transistors, and the second transistor is a P-type transistor; wherein
an input terminal of the first NOT gate is connected to a second electrode of the third transistor, an output terminal of the first NOT gate is connected to a first electrode of the first transistor, a second electrode of the first transistor is connected to an input terminal of the third NOT gate and an output terminal of the second NOT gate, and a third electrode of the first transistor is connected to a third electrode of the second transistor and a third electrode of the third transistor;
an output terminal of the third NOT gate is connected to a first electrode of the second transistor, and a second electrode of the second transistor is connected to an input terminal of the second NOT gate and a first electrode of the third transistor;
the first data input terminal of the first latch and the second data input terminal of the second latch are both a connecting terminal between the input terminal of the first NOT gate and the second electrode of the third transistor;
the first output terminal of the first latch and the second output terminal of the second latch are both the output terminal of the third NOT gate; and
the enable terminal of the first latch and the enable terminal of the second latch are both a connecting terminal among the third electrode of the first transistor, the third electrode of the second transistor, and the third electrode of the third transistor.

15. The GOA circuit according to claim 10, wherein the first pulse generator comprises a first-stage AND gate and a first buffer amplifier; wherein
a first input terminal of the first-stage AND gate is connected to the first clock signal, a second input terminal of the first-stage AND gate is connected to the enable signal output terminal of the enable module, an output terminal of the first-stage AND gate is connected to an input terminal of the first buffer amplifier, and an output terminal of the first buffer amplifier is connected to the first gate line of the row disposed corresponding to the first pulse generator; and
the first input terminal of the first-stage AND gate is the data input terminal of the first pulse generator, the second input terminal of the first-stage AND gate is the enable input terminal of the first pulse generator, and the output terminal of the first buffer amplifier is the output terminal of the first pulse generator.

16. The GOA circuit according to claim 15, wherein the second pulse generator comprises a second-stage AND gate and a second buffer amplifier; wherein
a first input terminal of the second-stage AND gate is connected to the second clock signal, a second input terminal of the second-stage AND gate is connected to the enable signal output terminal of the enable module, an output terminal of the second-stage AND gate is connected to an input terminal of the second buffer amplifier, and an output terminal of the second buffer amplifier is connected to the second gate line of the row disposed corresponding to the second pulse generator; and
the first input terminal of the second-stage AND gate is the data input terminal of the second pulse generator, the second input terminal of the second-stage AND gate is the enable input terminal of the second pulse generator, and the output terminal of the second buffer amplifier is the output terminal of the second pulse generator.

17. The GOA circuit according to claim 16, wherein the first buffer amplifier and the second buffer amplifier both comprise n stages of cascaded inverters, n being an odd number greater than or equal to 2;
wherein the input terminal of the first buffer amplifier and the input terminal of the second buffer amplifier are both an input terminal of a first-stage inverter, and the output terminal of the first buffer amplifier and the output terminal of the second buffer amplifier are both an output terminal of an N^{th}-stage inverter.

18. The GOA circuit according to claim 17, wherein each inverter of the n stages of cascaded inverters comprises: a P-type transistor and an N-type transistor;
a first electrode of the P-type transistor is connected to a constant high voltage level, a second electrode of the P-type transistor is connected to a first electrode of the N-type transistor, a second electrode of the N-type transistor is connected to a constant low voltage level, a gate of the P-type transistor is connected to a gate of the N-type transistor, and the second electrode of the P-type transistor is connected to a first electrode of the N-type transistor; and
the gate of the P-type transistor and the gate of the N-type transistor are the input terminal of the inverter, and the second electrode of the P-type transistor and the first electrode of the N-type transistor are the output terminal of the inverter.

19. The GOA circuit according to claim 1, wherein a P-type transistor in each of the plurality of GOA units is a P-channel thin film transistor made of low-temperature polysilicon, amorphous silicon, or a material resulted from a mixture of carbon, silicon, and germanium at any ratio.

20. The GOA circuit according to claim 1, wherein an N-type transistor in each of the plurality of GOA units is an N-channel thin film transistor made of metal oxide.

21. A pixel circuit having an internal compensation effect, the pixel circuit cooperating with the GOA circuit as defined in claim 1, wherein the pixel circuit comprises a first transistor T1, a second transistor T2, a third transistor T3, a fourth transistor T4, a fifth transistor T5, a capacitor Cₛ, a node, and a light-emitting unit; wherein
a second electrode of the first transistor T1 is connected to a data signal, a first electrode of the first transistor T1 is connected to a second electrode of the fourth transistor T4 and a first electrode of the second transistor T2, and a third electrode of the first transistor T1 and a third electrode of the fifth transistor T5 are connected to a second output terminal of a drive module in the GOA circuit; and
a first electrode of the fourth transistor T4 is connected to a high level, a third electrode of the fourth transistor T4 and a third electrode of the third transistor T3 are connected to a first output terminal of the drive module in the GOA circuit, a second electrode of the second transistor T2 and a second electrode of the third transistor T3 are collectively connected to a first electrode of the fifth transistor T5, a second electrode of the fifth transistor T5 is connected to a positive electrode of the light-emitting unit, a negative electrode of the light-emitting unit is connected to a low level, a first electrode of the third transistor T3 is connected to the node and the capacitor Cₛ in sequence and then connected to a high level, and the node is further connected to a third electrode of the second transistor T2.

22. The pixel circuit according to claim 21, wherein the first transistor T1 and the third transistor T3 are N-type transistors, and the second transistor T2, the fourth transistor T4, and the fifth transistor T5 are P-type transistors.

23. The pixel circuit according to claim 21, wherein each of the P-type transistors in the pixel circuit is a P-channel thin film transistor made of low-temperature polysilicon, amorphous silicon, or a material resulted from a mixture of carbon, silicon, and germanium at any ratio.

24. The pixel circuit according to claim 21, wherein each of the N-type transistors in the pixel circuit is an N-channel thin film transistor made of metal oxide.

25. A method for driving a display, comprising:
inputting an address signal to a row decoder in a gate driver on array (GOA) circuit of a display;
enabling the row decoder corresponding to the address signal;
outputting an enable signal to a pulse generator in the GOA circuit by the enabled row decoder; and
generating a pulse signal by the pulse generator to drive pixels in a corresponding row to operate.

26. The method according to claim 25, wherein the pulse generator generates a short pulse signal and a long pulse signal to respectively drive pixels in different rows to operate.

27. The method according to claim 26, wherein the pulse generator receives a long clock signal and a short clock signal to respectively generate the long pulse signal and the short pulse signal.

28. The method according to claim 27, wherein the pulse generator comprises a first pulse generator and a second pulse generator; wherein the long clock signal is input to a data input terminal of the first pulse generator, the short clock signal is input to a data input terminal of the second pulse generator, and the enable signal is input to a clock input terminal of the first pulse generator and a clock input terminal of the second pulse generator.

29. The method according to claim 28, further comprising:
resetting the enable signal output by the enabled row decoder.

30. The method according to claim 29, wherein the enabled row decoder is reset by a reset circuit.
